(19) United States
(12) Patent Application Publication
(10) Pub. No.: US 2026/0213031 A1
(43) Pub. Date: Jul. 23, 2026

(54) Spectral Selectors for radiactive capture and fission

(71) Applicants: Alberto Mizrahy Campos, Sr., Belo Horizonte (BR); Tarcisio Passos Ribeiro de Campos, SR., Belo Horizonte (BR)

(72) Inventors: Alberto Mizrahy Campos, Sr., Belo Horizonte (BR); Tarcisio Passos Ribeiro de Campos, SR., Belo Horizonte (BR)

(21) Appl. No.: 18/859,563

(22) PCT Filed: Jul. 1, 2023
(86) PCT No.: PCT/BR2023/050225

§ 371 Date: Oct. 24, 2024

(51) Int. Cl. G21G 1/08; G21F 9/00

(52) U.S. Cl. CPC G21G 1/08; G21F 9/001

(57) ABSTRACT

Resonant Spectral Selectors (RSS), configurations, components, and arrangements for selective radiative transmutation (n,g) and fission (n,f) in nuclide-target holders (69), useful for decontamination of radioactive waste, burning of fission products, production of radioisotopes and neutron activation analysis. RSS consists of support (58,59), peripheral reflector (10), primary source (20), pre-moderator (15), dynamic modulators (13, 24-30) with magnetic suspension (28-30), peripheral compartment (11), target-holder (69), heating (53) and cooling systems (65), and pressure control (64), ion generation (51), instrumentation (71), neutron source (20), permanent magnet motors (54,55) and rotation sensors (17,18). RSS produces optimized rates of fission and radioactive capture reactions in nuclides with Z from 1 to 110, achieved through selective interactions in the cross-sections XS(n,g) or XS(n,f) exhibiting a 1/v behavior at ~1 meV or in resonances ranging from ~10⁻³ to ~10⁵ eV. This is accomplished by a spectra of collective neutron distributions with precise mean energies and restricted standard deviation

### TECHNICAL FIELD

The present invention relates to the field of nuclear technology, specifically in decontamination of radioactive waste, production of neutron-rich radioisotopes, and analysis of nuclides by neutron activation.

### BACKGROUND ART

For each specific area of the technical field, one can describe tools and methods commonly employed.

Current techniques and practices for the treatment of long-lived radioactive waste are described in technical documents of the International Atomic Energy Agency, such as TECDOC, Predisposal Management of Radioactive Waste from Nuclear Power Plants and Research Reactors IAEA Safety Standards Series No. SSG-40, Specific Safety Guides STI/PUB/1719|978-92-0-109815-3, 83 pages. This document shows that the state of the art consists of storing radioactive waste in temporary and subsequent permanent repositories.

Current patents can demonstrate that the path followed for processing fissile waste produced in nuclear reactors continues to involve segregation, chemical separation, and storage procedures (GB2554068 by lan Scott; VN1/048166 by Toshinsky).

It is important to mention that there are experimental methods for transmutation of radioactive waste using high-flux nuclear reactors. However, burning these waste materials, even those with very long half-lives, in nuclear reactors is a risky task due to the introduction of additional contaminants and the need to keep them within the reactor core during operation cycle.

Regarding the production of neutron-rich radioisotopes, the technique involves exposing precursor nuclides to thermal fluency in nuclear reactors. The probability of reactions occurring in these precursors is directly related to the wide spectrum of neutron energies present in the reactor. Therefore, reactors not only transmute the desired precursor nuclides but also indiscriminately produce a wide range of undesirable contaminants through various reactions. These contaminants can be minimized by enriching the isotopic abundance of the precursor and allowing for the loss of activity (cooling) of the contaminants during a period after irradiation, which, however, increases costs and reduces the desirable specific activity.

Regarding the technique of Neutron Activation Analysis (NAA), nuclides are identified in a sample in parts per billion (ppb) through the signature of prompt gamma-ray (γ) emissions resulting from radiative capture reactions (n,g). However, due to the non-selective nature of the neutron spectrum, broad emissions of gamma rays and X-rays occur from various types of nuclides and reactions in the sample, making the analysis non-trivial. These emissions need to be analyzed in multi-channel detectors, compared with reference samples of known activities, and applied intelligent systems for discrimination and selection of intensity peaks based on information from nuclear databases of radiative emissions. Due to the non-selectivity of neutron spectra in NAA technique with respect to cross-sections (XS), a high flux of thermal neutrons is required for effective identification of many nuclides at minimal atomic concentrations.

The invention represents a paradigm shift with the generation of a selectively neutron spectrum in terms of energy and angular direction, by modulating the velocity of neutrons from a primary source. The three techniques mentioned earlier can benefit from the amplification or reduction of nuclear reaction rates by employing neutron fluxes with adjusted and precise energy spectra. Since each target nuclide presents characteristic radiative capture or fission cross-sections at distinct resonant energies, reactions with neutrons in a precise spectrum covering only such resonance energies can increase reaction rates in the target and reduce contamination from other nuclides. (Duderstadt, James J., Hamilton, Louis J., Nuclear Reactor Analysis, John Wiley & Sons, Inc, Michigan, 1976).

The main advantage of this invention lies in its ability to eliminate long half-life radioactive waste without introducing new contaminants, in controlled environments, and using compact-sized and relatively simple equipment. This equipment represents an advancement in nuclear technological development, effectively addressing the serious issues of radioactive contamination generated by nuclear industry waste. Additionally, it enables selective production of radioisotopes without activating undesired isotopes of the target radionuclide and enhances the efficiency of the NAA.

### SUMMARY OF INVENTION

The present invention describes Resonant Spectral Selectors (RSS) in their possible configurations, respective components, and specific arrangements.

The invention can be embodied as an equipment that appears in the configurations namely MB, MR, and MM. The individual device, called an RSS, is mainly composed of static and movable concentric cylindrical rings, along with other components. Specifically, the RSS consists of the following main parts: a support structure (58, 59); a peripheral static reflector (10); a static central core (15); movable cylindrical modulation rings, also known as halo rings (24-30), which can be suspended and supported by magnetic edge rings (67, 60; 65, 66); and a peripheral static compartment (11) with a target holder (69) for nuclear reactions. Additionally, the RSS includes a heating system (53), a cooling system (63), instrumentations (71), a neutron-generating source (20), one or more high and medium-speed permanent magnet motors (54, 55), rotation sensors (17, 18), and a pressure control system (64).

The main concept of the present invention encloses the production of optimized reaction rates for fission and radiative capture in nuclides with atomic numbers (Z) ranging from 1 to 110, which exhibit pronounced microscopic cross-sections (XS) for (n,g) or (n,f) reactions in the energy range: low ~0.001 eV, where XS follows a 1/v behavior, or in the range of Eₒ±dE, where Eₒ is the resonance energy, spanning from approximately 10⁻³ to 10⁻⁴ eV, reducing undesirable absorption rates outside of this spectrum. Such equipment enables nuclides X(Z, N), where Z is the number of protons and N is the number of neutrons, present in the target holder, to “transmute” into nuclides (Z, N+1) through radiative capture reactions or to undergo fission (n,f) and be eliminated.

The invention of the RSS can be applied to: i) the burning of waste containing high and low activity fissile products; ii) the burning of radioactive contaminants arising from various processes in industry and medicine; iii) the transfer of heat from decay and radiative transmutation to a coolant fluid, which in industry can generate chemical conversions, electric power, or heating; iv) the production of radionuclides through selective and pronounced nuclear reactions in their cross-sections (n,g) from their precursors; and v) the nuclide analysis of samples by neutron activation (n,g).

### Technical Problem

The generation of nuclear energy in thermal or fast reactors results in the production of radioactive waste that accumulates during the burning of fuel in any currently used cycle or technology. The radiation and heat-emitting fission products are initially stored temporarily within the reactor itself, in pools and special containers present in nuclear power plants, rendering the system radiologically unsafe. Accidents that occurred in nuclear power plants, such as Three Mile Island (USA), Chernobyl (former USSR), and Fukushima (Japan), raised concerns about the safety of nuclear reactors. Radiological and environmental damages were evident. Currently, the spent fuel from hundreds of nuclear power plants around the world becomes radioactive waste with half-lives ranging from decades to thousands of years, requiring disposal in secure repositories that guarantee its radiological safety for secular periods.

Contaminating radionuclides with long half-lives from the nuclear industry and the healthcare sector are undesirable for humanity, as they pose a high potential for environmental pollution and damage to human health without territorial restrictions.

Furthermore, the production of neutron-rich radioisotopes for industrial and medical applications also relies on nuclear reactors. However, this approach presents a significant limitation regarding the generation of contaminants, which often cannot be separated from the desired radionuclide.

In turn, the neutron activation analysis technique, commonly used with nuclear reactors, is entirely dependent on the neutron spectrum to which the samples are exposed. This broad spectrum of neutrons not only activates the desired nuclides but also all other nuclides and their isotopes present in the sample due to the diversity in the behavior of radiative capture cross-sections (n,g) of existing nuclei.

### Solution to Problem

The RSS equipment adjusts the neutron fluence on the target holder by utilizing a modulated energy spectrum tailored to the absorption characteristics of the target nuclide. In this way, the rates of radiative capture (n,g) and fission (n,f) reactions in a target nuclide X(Z,N) are amplified and controlled, while being limited for other nuclides.

The presence of high cross sections (XS) at cold energies (~meV) or the presence of nuclear resonances is a characteristic signature of the target X(Z, N), which is often not repeated in its own isotopes and adjacent chemical elements.

The technique proposed in this invention, through the RSS MB, MR, or MM configurations, solves the problem by combining pre-moderators and rotating modulators with specific angular velocities and radii. These modulators promote a differentiated scattering of neutrons from a primary source, based on the material, geometric, and dynamic characteristics of the medium. This results in the ejection of neutrons with the necessary energy and angular direction to interact with each desired target nuclide.

In another aspect, the present invention provides, in the target holder of the RSS, the specific nuclides exposed to modulated fluences that amplify their transmutation capability, even when they are contaminants from long half-life fission products. The neutrons ejected by the modulators react minimally with other nuclides present in the target holder whose cross sections (XS) are negligible in the projected spectrum region.

From a different perspective, the isotopes of a chemical element X exhibit differences in their responses to radiative capture absorption. This property allows, in an innovative manner, the selection of a unique isotope X(Ni, Z) that optimally responds to radiative capture transmutation at a specific energy, while this transmutation is innocuous to the other isotopes X(Nj, Z) (where i≠j). This phenomenon characterizes selective isotopic transmutation, representing an advancement in radiological decontamination techniques, radioisotope production, and neutron activation analysis.

It can be inferred that the present invention, in terms of its geometry, components, and material composition, differs significantly from current technologies employed for the burning of radioactive waste, production of neutron-rich radioisotopes, and neutron activation analysis, where the use of nuclear reactors is commonly practiced.

### Advantageous Effects of Invention

The present invention provides a solution for the elimination of long half-life radioactive waste without the need to reintroduce it into nuclear reactors or generate more radioactive waste, and without requiring storage in repositories. This represents a paradigm shift for the nuclear industry.

The invention enables the modulation of the neutron spectrum from a discrete primary source, creating an optimized energy distribution for the target radionuclide. This maximizes the rate of radiative capture or fission reaction, favoring the burning of fission products. Additionally, the invention allows for the selection of the target X(N,Z) among other nuclides, thereby reducing contaminating radioisotopes.

The practices of radioisotope production, neutron activation, and radioactive waste burning will be benefited by the resonant spectrum modulation technique.

### BRIEF DESCRIPTION OF DRAWINGS

FIG. 1 depicts the RSS MB configuration, half-symmetric on radial axis.

FIG. 2 depicts the resonant RSS configuration, referred to as MR, with MR1, MR2, and MR3 classes, half-symmetric on radial axis.

FIG. 3 depicts the RSS MM configuration, in MM1, MM2, and MM3 classes, half-symmetric on radial axis.

FIG. 4 depicts RSS in lateral view, longitudinal section, internal view, and top view.

FIG. 5 depicts RSS in a side view showing the lower structure and motors.

FIG. 6 shows the collective energy spectrum of neutrons as a function of radial spatial groups, without and with standard deviation plotting.

FIG. 7 shows mean energy of particle distribution in function of radial groups, and collective distribution as a function of energy at 0.9, 0.7, 0.5 and 0.4 R radial groups.

FIG. 8 presents the mean energy Eₘ of the Dₙ(Eₘ, S) distributions as a function of radial groups for RSS with a graphite MR modulator of radius R_{MR}=30.5 cm, without and with standard deviation plotting.

FIG. 9 presents the distribution of scattered particles Dₙ(Eₘ, S) in function of energy; and the collective distribution of dot product of velocities v1 and v2, both adjusted by equivalent Normal Distribution at specific positions R±dR.

FIG. 10 depicts the energy Eₘ in Dₙ(Eₘ, s) as a function of radial groups for distinct dimensions of the RSS modulator, using four types of materials and four axial angular rotations.

FIG. 11 shows the energy Eₘ in the Dₙ(Eₘ, s) distribution for RSS MB, with an MB modulator of radius RMB of 30.5 cm made of graphite.

FIG. 12 shows the energy spectrum Eₘ in the Dₙ(Eₘ, s) distribution as a function of radial group taken in RSS MM, with source types f1 (Watts function), f2 (D-D neutrons), and f3 (Li⁷(p,n) neutrons).

FIG. 13 shows an arrangement of RSS units in modules: MB, MR, and MM, including chemical element separators, heat exchangers, and flows of radioactive, decontaminated and coolant fluids.

FIG. 14 shows the neutron distribution D(Eₘ=720 eV, s=2*Eₘ) of RSS MM and the cross-section (XS) of Cs137 at Eₒ=720 eV; and the Dₙ(Eₘ=8 eV, s=16 eV) distribution of RSS MR and the XS of Sm-252 at Eₒ=8.03 eV.

### DESCRIPTION OF EMBODIMENTS

The configurations of the Resonant Spectral Selector (RSS), based on the specific arrangement of its rotating and static modules, along with target compartments, can be applied in radiative transmutation or induced fission processes. The nuclides contained in the target holders (69) are bombarded by the RSS, which uses a modulated spectrum derived from a primary neutron source (20). This spectrum is designed to achieve a Normal Distribution Dₙ(Eₘ, s), with a mean Eₘ and standard deviation s, as close as possible to the specific resolved resonance energy Eₒ, or in the low-energy region (~0.001 eV), where neutron capture or fission rates are maximized.

For better understanding, three configurations can be defined for the RSS, namely: i) RSS MB; ii) Resonant RSS MR; iii) Resonant RSS MM.

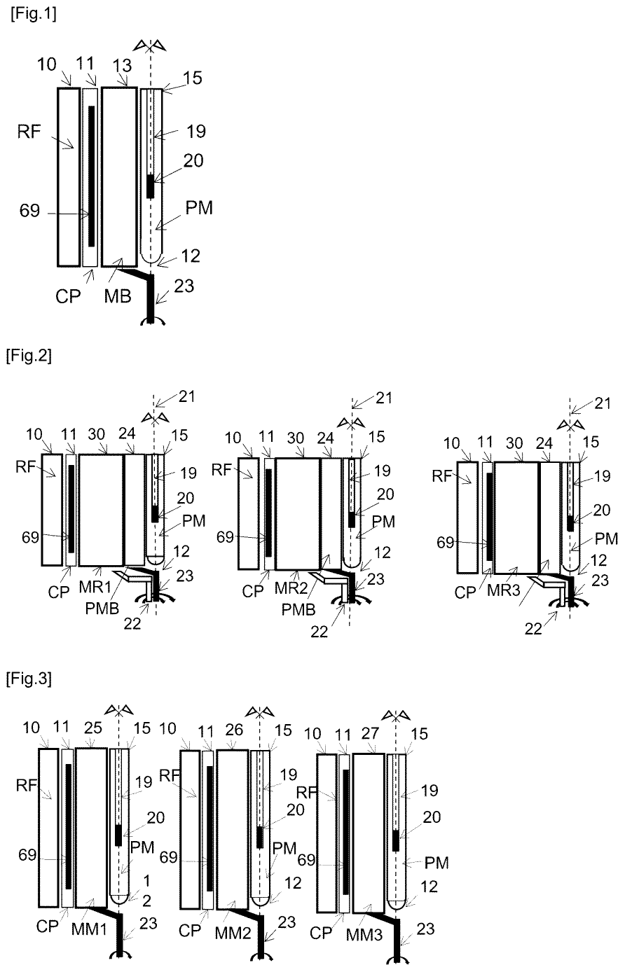

FIG. 1 depicts a representation of the RSS MB model. The RSS MB device consists of a static pre-moderator PM (15) with an axial central perforation (19) and a primary source FT (20), along with the rotating modulator MB (13), which reduces the neutron energy to the low-energy range (13). There is also the peripheral compartment CP (11) and the target holder (69), followed by the reflector RF (10). This configuration is supported by a low-speed rotating motor (54) connected to the shaft (23).

The pre-moderated neutrons from the source FT are transported to the inner periphery of the MB ring (13), which rotates at a specific speed to reduce their neutron energy to a low level (around 0.001 eV) and adjust their angular direction to match the neutron velocity in the radial orientation towards the outer edge of the MB (13) modulator, tangent to the RMB radius of the modulator's outer surface.

The process of interest in RSS MB involves radioactive transmutation through (n,g) reactions in radionuclides that do not have resonances or whose peaks (Eₒ) do not occur at energies approximately between ~0.01 and 50 eV. Many of these nuclides, in turn, have high microscopic cross-sections XS at cold energies (~0.0005-0.01 eV), which are expressed by a XS behavior known as the inverse velocity law (1/v) specifically in the radiative capture (n,g) and/or fission (n,f) XS. With a neutron fluence of around ~1 meV, high interaction rates occur in the XS (n,g) and/or XS(n,f) in the target nuclide. Thus, this RSS MB configuration caters to nuclides that exhibit this condition in their XS(n,g) or (n,f). A neutron energy distribution in the range of cold neutrons ~0.01 to 0.0005 eV can be achieved at the MB modulator's output surface.

FIG. 2 shows the RSS MR configuration, defined as the resonant RSS configuration. RSS MR consists of a primary source FT (20), a static pre-moderator PM (15), and a rotating cylindrical ring for neutron velocity reduction (downscattering) called PMB (24). There is the peripheral compartment CP (11), where the target holder (69) is positioned around the movable cylindrical rings MR and inner PMB (13-28-30). The CP is followed by the static reflector RF (10).”

FIG. 2 also depicts the axes that transmit the rotating movements (23) and (22). The PMB is directly coupled to the axis (23), while the MR modulator has a magnetic coupling between MR base (28-30) and axis (22).

In the RSS MR configuration, it is possible to adjust the angular velocity and adapt the outer radius of PMB (24) to reduce the energy of the neutrons at the PMB output, reaching energies close to ~0.02-1 eV, defined here as epithermal neutrons. The PMB, through downscattering collisions, further reduces the energy of the pre-moderated neutrons from PM, but it does not operate in the cold neutron range. The angular velocity and the RPMB radius must be adjusted so that the energy at the periphery of PMB (24) corresponds to values slightly below the resonance energy of interest, Eₒ. Thus, the PMB (24) is responsible for reducing the energy of neutrons above the range of cold neutrons and below the resonant energy to be achieved by Eₘ in the Dₙ(Eₘ, S).

In RSS MR, the MR modulator (28, 29, or 30) follows the PMB ring (24). MR operates preferably by increasing the energy of the neutrons (upscattering). The MR modulator generates neutrons at the output of its outer surface, represented by Dₙ(Eₘ,s), with a radial orientation and an average energy Eₘ equivalent to the resonant energy Eₒ of the XS(n,g) cross-section of the target nucleus present in the target holder (69) in CP (11). The angular rotation speed of the MR (28-30) is adjusted according to the desired resonance energy, which is different from the rotation speed of the PMB (24).

The RSS MR configuration is supported by two rotary motors (54, 55), one with low speed and the other with high angular speed, with rotation controls (56, 57).

FIG. 2 depicts the RSS MR configuration, where the PM, PMB, and MR elements orient the velocity and modulate the energy of neutrons from the primary source to meet a specific resonant energy Eₘ corresponding to the E0 of a resonance in the radiative capture cross-section, XS(n,g), of a target nucleus XA. This function enables the transmutation of nuclides, where XA is converted into XA+1 through the (n,g) reaction at the corresponding resonance energies.

Some nuclides, especially those with high atomic number (Z), exhibit many resonances in the XS(n,g) or XS(n,f) cross-sections. Based on the RSS MR configuration, the resonance energies of XS(n,f) can be utilized for the elimination of the radionuclide X^{A} contaminants resulting from fission products (PF). Furthermore, the resonance energies can be employed in the burning of low-enriched uranium-235 (less than ~2%) in spent fuel rods, among other applications.

The RSS MR configuration modulates the neutrons and irradiates the peripheral compartment (11) in which the target is enclosed, resulting in the transmutation of present nuclides that exhibit resonant behavior in the XS(n,g) or XS(n,f) cross-sections.

FIG. 3 depicts the RSS MM configuration. The RSS MM consists of a selector that utilizes a modulator with a high atomic number (Z) and high angular velocities, allowing the neutrons to reach energies above ~50 eV-1 keV at the output of the ring. In this case, the MM modulator is capable of handling cross-sections that have resonances at higher energies Eₒ above 50 eV.

The RSS MM, through its MM modulator, achieves intermediate energies by interrupting the downscattering process. It can be said that downscattering was not fully accomplished, and the MM modulator reduced fast neutron energies to values close to epithermal energies. This process is essential, as the MR modulator may be limited to energies up to 50 eV due to design parameters such as angular rotation speed and module radius, which may be constrained by radial dimensions and current angular rotation of the motor technology.

In the case of RSS MM, where a resonance occurs at Eₒ between 20 and 50 eV, it can be advantageous to adjust the input energy of the MM slightly above Eₒ since the MM primarily operates in downscattering of high-energy source neutrons. In this scenario, it is possible to include the PMB before the MM. It is important to mention that this specific condition has not been illustrated on figures.

RSS MM differs from RSS MR in that MR achieves the upscattering process through resonance tunneling. RSS MR adjusts the average energy of the neutron distribution to the resonance energy, ensuring a specific behavior of the target nuclide. On the other hand, RSS MM is suitable for intermediate resonance energies, ranging approximately from 50 eV to a few keV. However, RSS MM is not capable of providing a normal neutron distribution and lacks the fine-tuning capability in resonance energy (Eₒ) that RSS MR possesses.

Due to the neutron distribution Dₙ(Eₘ~Eₒ, s) being directed towards the inner target holder (69) in the CP compartment, nuclides present in 69 do not undergo transmutation when attend the two following conditions: do not possess resonances in Eₒ in RSS MR or MM; or do not have high cross-sections in cold regions with 1/v behavior in the case Eₒ~1 meV in RSS MB. This fact is extremely beneficial as the decontamination of a radionuclide X(N,Z) through an MB, MM, or MR modulators can result in little or no additional contamination in other nuclides, making the decontamination selective only for X-target.

RSS MB features the same structures described in RSS; however, it may not have the upper and lower magnets coupled to the modulator due to the low rotation speed of MB, allowing for a direct coupling to the motor. RSS MR, on the other hand, has a magnetic coupling for the modulator MR.

Regarding the dynamic modulators known as MB, MR, and MM, these can be further detailed as follows.

The Low-Energy Modulator (MB) (13) is a rotating ring that operates at low speeds. It is designed to receive a spectrum of diffused neutrons at the inner interface, with a spectrum close to the Maxwell-Boltzmann distribution, which is near thermal energies (~eV) at the output of the Pre-Moderator PM (15). The MB can adjust this neutron spectrum to very low energies, close to 0.001 eV (1 meV), at the outer interface. This is the design energy for the MB (13), although it can operate at even lower energies if necessary.

The MB is commonly fabricated using elements with low atomic numbers (Z) with low radiative absorption XS and exhibit a high scattering cross-section for efficient neutron downscattering. Materials commonly used include compounds such as fluorine (F), carbon (C), deuterium (D), beryllium (Be), and others, without specific restrictions.

FIG. 1 depicts the Low-Energy Modulator (MB) in RSS MB. MB directs the neutron beam tangentially to the radius at the position corresponding to the outer radius of MB (13). Neutrons pass through MB (13) and assume a normal distribution, represented by the Dₙ(Eₘ, S), with an average energy Eₘ, where the radius RMB and angular velocity wₙ are designed to make Eₘ close to ~1 meV.

FIG. 3 illustrates the Medium-Energy Modulator (MM) (25-27). MM is composed of a movable ring that rotates at an average speed of on the range of 0.5 up to 9·10⁵ rotations per minute. It is designed to receive a spectrum of sub-thermalized neutrons from the pre-moderator PM (15) diffusely at the inner interface. MM reproduces, at the outer interface with radius RMM, a distribution represented by Dₙ(Eₘ, s) for energies Eₘ covering the epithermal range of about 50 eV to 1 keV. However, this distribution D does not necessarily follow a normal distribution Dₙ.

The MM modulator is typically manufactured using materials with intermediate atomic numbers. Through a limited downscattering process, which results in reduced energy loss per collision compared to light elements, MM performs modulation and direction of the neutron beam close to the radial direction at the output interface, at the outer radius RMM. In this way, the RMM of the modulator can be adjusted to provide neutron energy outputs close to the resonance energy in the range of tens of eV to keV before the predominant downscattering process is completed and predominantly upscattering begins.

The output energies of the MM are impossible to be achieved by the Resonant Modulator (MR) due to the requirement of high rotational speed and a considerably larger radius, which is currently not feasible with the technology available for motors.

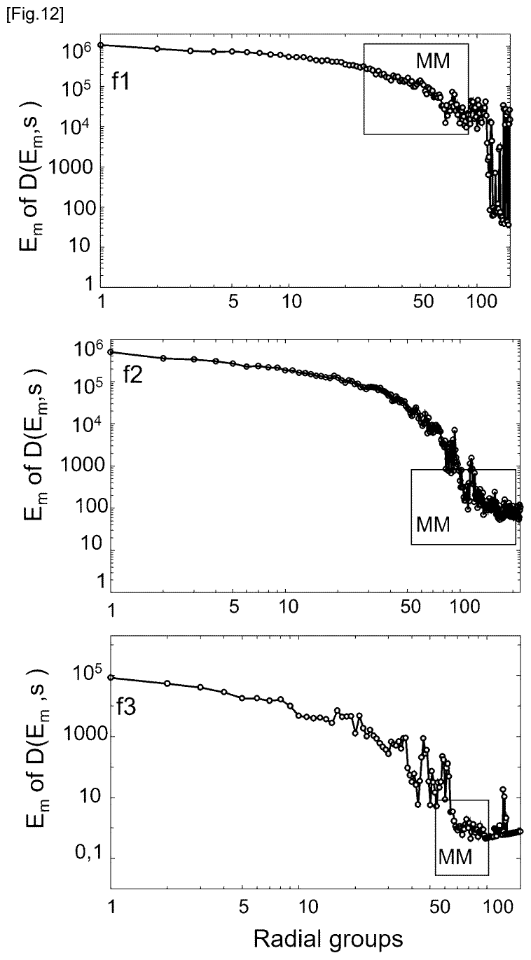

FIG. 12 illustrates a set of neutron distribution profiles D(Eₘ) for MM modulators. The MM is an alternative to the Resonant Modulator MR for nuclides that do not follow a 1/v behavior or have a low (n,g) cross section in the cold neutron region, and do not exhibit resonances in the energy range of 0.01 to 50 eV. The MM operates by interrupting the preferred downscattering process before initiating the preferred upscattering process. Therefore, the MM can be used for the transmutation of certain nuclides that have resolved resonances above the energies close to epithermal or thermal neutrons. Commonly used materials for the MM include compounds of Zirconium, Beryllium, Graphite, and other elements with intermediate atomic numbers.

The Resonant Modulator MR, on the other hand, is a high-speed rotating ring (>10⁵ rpm) that can be maintained in magnetic suspension. It can receive, at the inner interface, a radial and partially oriented neutron spectrum at low energies (~0.02-1.0 eV) provided by the Pre-Moderator PMB (24). The MR adjusts this spectrum to a distribution Dₙ(Eₘ, s), where Eₘ is close to the resonant energy Eₒ of the cross section (XS) of the target material in question, covering the range of resonance energy on 0.01 to 25 eV at the outer interface of the MR.

The MR is commonly manufactured using compounds of intermediate atomic number elements such as Zirconium, Beryllium, or Graphite, without specific limitations. It provides a neutron output at the outer radius R_{MR}, directing the beam in the radial direction.

FIG. 2 depicts the MR modulators within the configuration RSS MR, half-symmetric on radial axis (21).

The axial height of the MR modulator and PMB is calculated to reduce axial neutron leakage and maintain the appropriate spectrum at the output of the ring. At the edges of the MR rotating ring, at the interface between the upper and lower faces, magnetic rings (59 and 60) are present, fixed to the component to keep it suspended, without friction with the side parts.

It is possible to subdivide the MR and MM modulators into classes, arbitrarily numbered in this invention as 1, 2, and 3, or more.

Regarding the subdivision of modulators into classes, it is known that a specific radius Ri and a specific angular velocity wₙ are responsible for generating a neutron distribution D(Eₘ, s), with an average energy Eₘ and standard deviation s, at the output of an MR or MM modulator. Thus, D(Eₘ, s) is a function of the par of variables (Ri, wₙ). Due to the wide range of resonant energies Eₒ present in more than 3000 nuclides, it is proposed that an MR or MM modulator, with radius Ri, be able to cover a predefined range of energies from the resonant spectrum within the interval [Eₐ, E_{b}]. To achieve this, the MR and MM modulators can be designed with defined Ri and wₙ to operate at an energy Eₘ that represents the average of the interval [Eₐ, E_{b}]. The radius R is determined in such a way that, with an arbitrary operational angular variation Δw of +100% (up to 500%) of the nominal velocity wₙ, it is possible to reproduce D(Eₘ(w), s) at the output of the modulator, where Eₘ(w)~Eₒ∈[Eₐ, E_{b}], as required by the operator for the transmutation of the target X(N, Z).

In this way, the MR and MM modulators are divided into classes based on the clustering of resonances. For example, three classes are defined for MR, named MR1, MR2, and MR3, in a non-restrictive manner, while for MM, one can have MM1, MM2, and MM3. For instance, MR1 class covers the energy range of 10−3 to 1 eV, MR2 from 1 to 6.5 eV, and MR3 from 6.5 to 12.5 eV. As for MM, we have MM1 from 20 eV to 50 eV, MM2 from 50 eV to 100 eV, and MM3 above 100 eV. It is important to note that the limits and the number of intervals can be changed in a non-restrictive manner. Each class can address a specific group of nuclides, allowing variations in the nominal angular velocity of the modulator to adjust the energy Eₘ to approximate Eₒ.

FIG. 2 illustrates the MR1, MR2, and MR3 classes of MR modulators, half-symmetric on radial axis (21).

FIG. 3 illustrates the MM1, MM2, and MM3 classes of MM modulators.

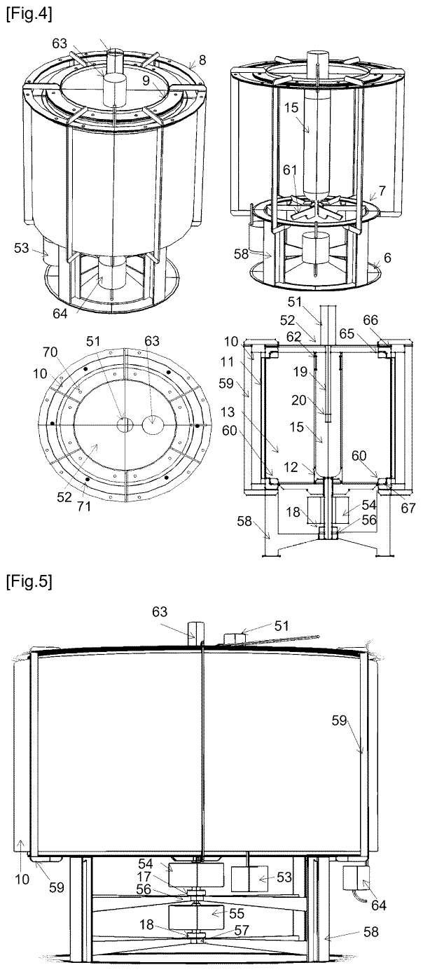

FIG. 4 illustrates RSS selector. The depicted modulator consists of a solid rotating ring, shaped like a cylindrical halo, made of a selected material according to the desired conditions for modulating the spectrum at the inner surface (input spectrum) and outer surface (output spectrum) of the rotating ring. It is also possible to include gears and use only one motor, which generates enough power to move the main modulator and, if necessary, a dynamic pre-moderator PMB. The speed of PMB can then be reduced by the gears.

FIG. 4, in the top view, illustrates the position of internal instrumentation rods (71) within the RF reflector (10). The peripheral compartment CP (11) and the levitation magnet control screws (70) are also highlighted. In a cross-sectional view of the RSS, the CP (11), RF (10), side and base support structures (58, 59) are shown, as well as the support of magnetic bearings (56). One can also observe the angular velocity meter (17, 18), high-speed motor (54), upper cover (63), ion generator (51) that impacts light nuclei in 20, and cooling plates (62). Furthermore, the pre-moderator PM (15) and lower magnet (60) can be identified. In the side view, one finds the cooling controller (65), heating controller (53), and pressure control system (64).

FIG. 5 presents a three-dimensional lateral view of the MR RSS, showing in this case the possibility of coupling two motors (54, 55), with each one being responsible for the rotation of the PMB pre-moderator and the MR modulator, respectively.

FIG. 4 and FIG. 5 illustrate the general components of the RSS, which include: a static central cylinder PM, a neutron source in 20, produced by a neutron generator (51), pre-moderators PM and PMB, modulators MB, MR, and MM, peripheral compartment CP (11), and target holder (69), peripheral reflector RF (10), and electromechanical system, positioned at the bottom.

Additionally, the following systems are present: heating system (53); cooling system (63); pressure alteration system (vacuum/pressurizer) (64); instrumentation (71); neutron generating source (51); high-speed permanent magnet motor, single (54) or multiple (54, 55); rotation speed meters (17, 18), and magnetic bearings (56).

FIG. 1 to FIG. 3 illustrate the concentric cylindrical rings or halos (10, 13, 24 to 30) positioned around the axis (radial symmetric, 21) of the static central cylinder PM. The RSS can contain only one rotating solid ring (13) as the RSS MB or multiple concentric rotating rings, 24, 28-30 as the RSS MR, or 25-27 as the RSS MM. Each ring allows a nominal angular rotation wₙ, with rotation axes (22 and 23) in the axial direction accommodating arbitrary angular speeds.

Regarding the static and dynamic cylindrical halos, it can be added that the RSS features a central PM cylinder (15), a rotating pre-moderator ring PMB (24), and three types of rings classified as modulators, depending on the RSS configuration. These modulators are the Low-Energy Modulator MB (13), the Medium-Energy Modulator MM (25-27), and the High-Energy Resonant Modulator MR (28-30).

The ring used for PMB (24), and MB (13) operates at low speed and does not require levitation. On the other hand, the ring used for MM and MR operates at medium and high speeds, and magnetic levitation is desirable to reduce friction. Levitation is employed for the MR ring.

The pre-moderator PM (15) houses the primary neutron source (20) and performs partial pre-moderation of the neutrons, limited to the outer radius RPM of the PM. PM alters the spectrum of fast neutrons, of the Watts or Maxwell-Boltzmann type (ranging from a few tens of keV to MeV), into a subthermalized spectrum. This results in a partially isotropic diffuse angular distribution at the periphery of the PM cylinder (15). The material used for the PM consists of elements with low atomic number, typically compounds containing hydrogen or deuterium, oxygen, fluorine, beryllium, among others, without limitation.

FIG. 2 illustrates the low-speed Pre-moderator PMB (24). The PMB performs the pre-moderation of fast neutrons to epithermal energies, around ~1.0 eV. Preferentially, downscattering occurs, reducing the energies of fast neutrons. The PMB plays an initial role in modulating the angular direction of neutrons. It is composed of low atomic number elements such as hydrogen, carbon, deuterium, fluorine, beryllium. The PMB is a rotating pre-moderator, with an angular velocity equal to or near that of the MB modulator.

Additional pre-moderation can be performed at the input of the MB and MR modulators, which contributes to the radial and wₙ (angular velocity) reductions of the MB and MR.

FIG. 2 shows the PMB (24) in the MR RSS. It is important to meet energies lower than the resonance energy Eₒ at the entrance of the MR modulator, so that the energy evolves with the radius, as MR operates preferentially in upscattering. When the PMB precedes an MR, the PMB pre-moderator (24) is designed in terms of wₙ and RPMB radius, so that the average output energy is in the range of 0.1 to 1 eV.

To provide further clarification, the central cylinder includes the static neutron pre-moderator PM (15) and has a central axial bore (19) where a neutron source FT (20) is internally inserted, positioned at the average axial height.

The PM (15) is fixed at the top of the support structure. At the bottom of the cylinder, there are curved lower edges, creating a chamber for the coolant (12). The PM (15) is constructed with low atomic number materials (H, D, F, C, Be, O); however, its pre-moderation radius is insufficient to fully moderate the neutrons to thermal energies. Therefore, the neutrons are pre-moderated and transported to the inner surface of the dynamic modulator diffusely by Fick's law. The dynamic modulator will adjust its energy to the required value.

In turn, the primary source (20), positioned in the PM, can, for example, be a point source such as AmBe, PuBe, or Cf-252, or it can be a neutron source generated by fusion reactions of D-D or D-T, where the targets (20) are D and T, and the incident ions D+ (or D−) are provided by a deuterium accelerator for (d,n) reactions; or H+ (or H−) for (p,n), provided by an ion accelerator with sufficient energy to bombard targets of light chemical elements such as D, T, Li, Be, or B, located at 20. The ions are injected and directed towards the tube in the center of the ring (19), hitting their target (20). The neutrons from (*,n) reactions are produced in different spectra, specific to each nucleon-nucleon reaction, usually in fast energies. These sources represent widely known and publicly available technologies in both the academic and industrial fields, and will not be described in this document, as well as the methods for accelerating the incident ions onto the target.

Also, fission material can be included close the neutron source in PM for improve fluxes by subcritical processes; however, it is not shown in figures.

The cooling of the target (20) when bombarded, impregnated with D, T, Li, Be, or B, can be performed internally in the PM (15), along with the cooling of the cooling plates (62) located on the top of the PM (15). The neutron spectrum generated at 20 depends on the kinetic energy of the incident ions (H−, H+, α+, D+), which must possess energies above the specific threshold for nucleon-nucleon reactions.

To clarify the connection between the axes (22, 23) of the electromechanical system and the rotating rings (13, 24-30), it is important to mention that when there is only one low-speed rotating ring (13, 24), this ring can be directly connected to the rotor of a motor (54).

When there are multiple rotating rings with different nominal angular velocities wₙ, it is feasible to incorporate an electromechanical system that includes more than one motor (54, 55) with hollow shafts.

Technologies such as magnetic coupling, gears, and motors with permanent magnet stators and rotors are widely known and used in the market, without requiring detailed technical specifications or specific information about their connection and coupling.

FIG. 4 represents a view a cross section of the RSS. One can identify RF (10) and CP (11) components. In it, the four internal concentric magnetic rings (65, 66, 60, 67) are visible, arranged in pairs, with one pair at the top (65-66) and another pair at the bottom (60, 67). It is also possible to see the static central cylinder (15), which is fixed at the top of the structure (not shown), the fins (61) used to position the modulator (28), the base support structure (58), and separately, an MR modulator (13) of the cylindrical halo type, with magnetic rings attached to the upper face (65) and lower face (60).

The magnets present in the upper part (65, 66) and lower part (60, 67) of the MR or MM modulator are positioned over magnets of the same pole, resulting in permanent repulsion (28-30) both in the upper and lower parts. On the upper part of the support structure, there are metal rings with perforations for the placement of screws (70). These screws allow for vertical adjustment of the rotating ring. The asymmetry in tightening the screws enables a differential axial and radial position of the modulator, allowing for its levitation.

FIG. 4 presents the support structures (58, 59) of the RSS, constructed of metal, steel, carbon fiber or aluminum, for example. This structure includes fastening elements to position the rotating motor on the base (58), whose shaft is fixed in a magnetic bearing (56, 57) in the lower position. The rotor shaft is centered and connected to metal vanes (61). On top of the vanes, there is a circular metal base that can maintain a magnetized connection, and on this base, the rotating modulator, such as the MR, MB, MM, or the low-energy pre-moderator PMB, is fixed. Both on the upper and lower parts of the support structure, there are structural elements where the sets of magnetic rings (66 and 67) will be attached. The coupling between the base and the MR and MM modulator is magnetic, without physical contact, due to the high rotation speeds (~>10⁵ rpm). However, under low rotation speed conditions (~<10⁵ rpm), there may be physical contact such as with the MB and PMB modulators.

FIG. 5 illustrates the condition of two motors, which can have permanent magnet rotors and coil stators, and may include gears to increase or decrease the speed.

FIG. 5 illustrates the axes (56, 57) of the selector. These can be equipped with magnetic bearings to provide proper support. The connection between the high angular velocity rotating modulators (specifically 25-30) and the motors can be achieved through magnetic interaction, thereby eliminating any direct mechanical contact and friction between the high-speed rotating modulators and their mechanical rotating parts (22, 23).

FIG. 5 illustrates the electromechanical system and motors (54, 56). The operation mode, geometric configurations, and materials of the permanent magnet motors (54, 55), which are connected to the modulators MB, MR, MM, or PMB, with or without gears, and with or without magnetic coupling, are widely known technologies based on academic and technological knowledge that are already disseminated and publicly known. Therefore, it is not necessary to provide specific details or elaborate descriptions about these motors and gears. The mention of their existence, along with the axes and their positions, is sufficient. It is important to note that there may be variations in the electrical and mechanical characteristics of these motors, such as dimensions, power, and shaft coupling, without representing advancements in the technology described in this invention.

Regarding the peripheral compartment (CP) (11) and target holder (69), the CP component (11) found in the configurations RSS MB, MM, and MR consists of a concentric ring fixed to the device structure (59). The CP is composed of a hollow capsule (11) that contains a second inner capsule serving as the target holder (69), forming a double wall. The target holder (69) is where the material containing the target nuclide, referred to as X(N,Z), to be transmuted, is placed.

The target in 69 can be solid, liquid, or gaseous.

In another approach, the target holder can be filled with a liquid where the nuclide is dissolved in an inert solvent, which has a low absorption cross-section in the desired spectrum.

Furthermore, it is possible to replace the chamber in the peripheral compartment with solid cylindrical rods distributed inside the CP compartment (11) or passing through it, arranged in the axial direction. In this case, the rods are exposed to neutrons originating from the internal rotating modulator MB, MR, or MM. This condition is ideal for the direct irradiation of burned fuel rods, ensuring an adaptation of the neutron spectra to the cross-sections of the fission products.

The peripheral compartment and the target holder can be subdivided into angular sectors, allowing them to be disassembled and removed individually without the need to completely dismantle the RSS. This enables the use of different targets in each sector or the individual isolation of sectors for radiological safety reasons.

FIG. 4 illustrates the RF reflector (10). This component is in the peripheral part of the device and consists of a static concentric ring (10) that is coupled to the support structure. This ring serves as a neutron reflector (10). The reflector is composed of a material with a high capacity for elastic neutron scattering, which has a relatively high atomic number (Z) to prevent energy losses in elastic collisions and a very low neutron absorption cross-section in the spectrum used for the target contained in the peripheral compartment. Examples of materials used may include Teflon, Polyethylene (natural or with incorporated D), Graphite, Zirconium, Heavy Water, among others, in a non-limiting manner.

When the material selected for the RF peripheral reflector can moderate neutrons to thermal energies, Boron is added to the outer peripheral layer of the reflector. This is done to capture thermal neutrons that may escape from the RSS. This protection may also be present at the base and top of each pre-moderator PMB and PM, as well as in the modulators MB, MM, and MR.

Regarding shielding, due to the radiative capture reactions involved in the operation of the RSS, X-rays and gamma rays are emitted, which need to be properly shielded and removed from the environment. However, the inclusion of internal shielding against gamma rays or even escaping neutrons was not planned in the RSS. Since the equipment can be coupled in different environments, the decision was made to add external static shielding for gamma rays and neutrons in the environment where the RSS will be operated. It is worth noting that the specific details of this radiological protection in the environment will not be addressed in this document, as its design is not within the scope of the present invention.

Regarding the cooling system (65), it is responsible for controlling temperatures in different environments: i) the chamber (12) located in the lower region of PM (15), which is filled with a cooling liquid; ii) the source (20), when it generates neutrons through ion bombardment; iii) the cooling plates, such as Peltier-type plates (62), which are positioned on the upper surface of PM.

The cooling plates are responsible for condensing the gases from the cooling liquid, which evaporate at the interfaces between PM (15) and MB (13). The reactions in the source occur due to collisions of ions, produced in the ion generator (51), with light nuclei such as D, Be, Li, among others, in FT (20). The cryogenic liquid present in the chamber (12) is responsible for cooling the modulator MB (13) or PMB (24). Inside PM (15), there are thin tubes through which the cooling fluid (not illustrated) circulates, facilitating heat exchange with the cooling plates (62) and the source FT (20).

Regarding the instrumentation, it is installed on rods (71) inside the reflector (10), positioned on the external surface of CP (11). Among the instruments to be installed are a gamma radiation meter (71) coupled with a gamma spectrometer (71), temperature gauge, and a pressure gauge for the chambers 69 in CP (11).

FIG. 4 illustrates the position of the instrumentation, with entry at the top of the RSS.

As part of the instrumentation, gamma spectrometry allows monitoring the type and quantity of nuclear reactions, such as radiative capture (n,g) or fission (n,f), occurring in CP (11). The data obtained through gamma spectrometry can be used for neutron activation analysis, enabling the identification of the nuclide in question by characterizing the energy and intensity of the generated gamma rays and X-rays, providing a signature of the nuclide X(N,Z) that can be compared with nuclear databases. This capability is sufficient to operate the RSS MB or MR in neutron activation analysis.

The presented neutron simulations were developed to demonstrate the collective behavior of particles inside the dynamic pre-moderators and modulators. These simulations employed nuclear data (nuclear libraries: ENDFB-V/VIII.0, JEFF-3.3, EAF-2000, TENDL-2019, citation list) and stochastic nuclear codes MCNP6 (Durkee, J. W. et al., MCNP6 moving objects Part I: Theory; Part II, Prog. Nucl. Energy, 2016).

In the simulations, subroutines developed by the authors were coupled, considering probability and statistical evaluations, as well as physical phenomena of nuclear scattering and absorption interactions that occur within the materials of the RSS. Three-dimensional collisions of two bodies with different masses, initial velocities, and angular velocities were analyzed. Multigroup treatment was considered, with spatial and energy group discretization.

The simulations also considered thermal vibration and temperature variations of the medium. The physics and mathematics involved in the modeling are complex but are within the academic knowledge and public domain, widely disseminated in specialized literature in the nuclear field, as demonstrated, among other sources, in Harrisson G. et al, Nuclear Inst. Meth. In Physics Research, Section A., Vol. 959, 2020.

The dimensions of the RSS can vary according to the diameter of the rotating rings and the central static moderator, which are determined by the type of material to be transmuted and the neutron spectrum of the primary source. However, in terms of height, the machine is designed to minimize axial neutron leakage while maintaining an appropriate spectrum at the interface of each ring, in accordance with the characteristics of the spectrum tailored to the target to be transmuted or fissile.

The subject matter can be better understood through the following examples, which are not exhaustive.

### EXAMPLES

### Example 1

Let's consider an MR-type RSS made of polyethylene, with a rotation speed of 5·10⁵ rpm, a diameter of 30.5 cm, and a thermal temperature of the medium at 250 K. The developed software analyzed 2000 particles, with tracking of 500 collisions per particle. Neutron escape occurs through the outer edge of the modulator, which was discretized into 62 spatial groups based on radius. Neutrons enter the internal surface of the MR modulator following a velocity distribution following the Maxwell-Boltzmann spectrum, with a standard deviation of 1554 m/s and an average energy of 0.03787 eV (with a minimum of 0.094 eV and a maximum of 0.334 eV).

The RSS maintained an energy range of 0.12 eV to 0.59 eV internally within the rotating MR ring. The maximum transport length in the MR was 1.728 m, while, in the region of lower energy, the mean free path (m.f.p) was 0.88 m. The minimum energy in the MR was recorded at 2 cm from the internal surface, corresponding to the input spectrum.

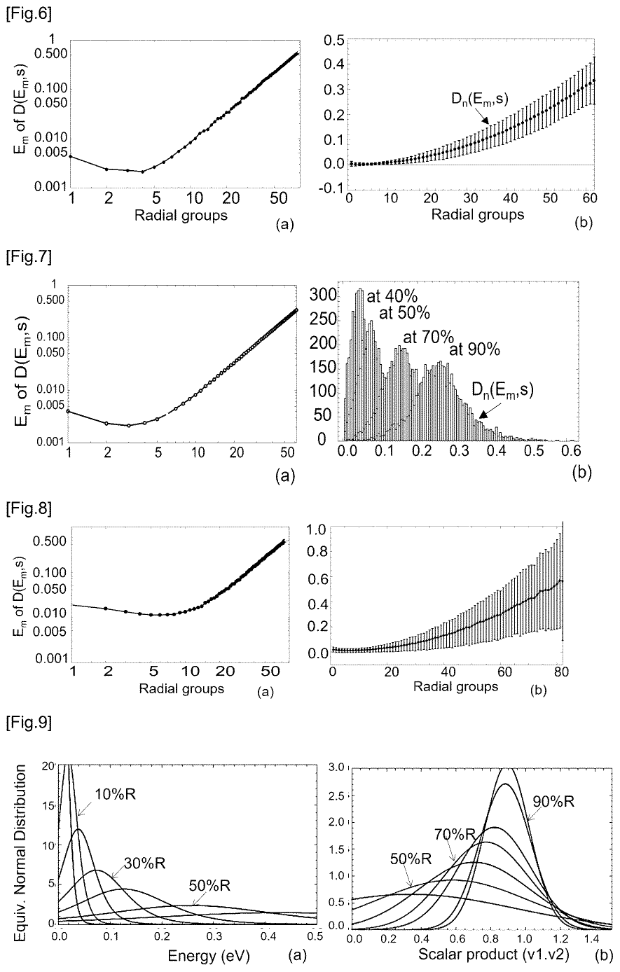

FIG. 6 displays the mean energy Eₘ of the Dₙ(Eₘ, s) distribution of the collective neutron energy spectrum in relation to the discretization of radial groups Np(i) (R=0.005*(Np+1)).

FIG. 6(a) is presented on a log-linear scale and without including the standard deviation. We can observe that there is a region of minimum energy of Eₘ near Np=5. The standard deviation s of the energy Eₘ with respect to the radius was evaluated for each spatial group, with the minimum occurring in group Np~5 and the maximum in group Np=62. On the other hand, as we increase the radius, there is an increase in the average energy Eₘ of the distribution.

FIG. 6(b) is presented on a linear-linear scale and with the inclusion of the standard deviation, these characteristics of Dₙ(Eₘ, S) are also evident.

The probability distributions of the collective particle energies D(E) in the regions R±dR were divided into 62 groups with an interval of 0.5 cm. The considered positions were 0.4 R, 0.5 R, 0.7 R, and 0.9 R.

FIG. 7(a) illustrates the average energy Eₘ in the distribution of the energy spectrum Dₙ(Eₘ, s) in relation to the radial grouping, considering the established Np groups.

FIG. 7(b) presents the number of particles as a function of energy for radial groups at 0.4 R, 0.5 R, 0.7 R, and 0.9 R at the dR interval.

### Example 2

In this example, let us consider an MR-type RSS with an MR modulator of radius R_{MR} of 30.5 cm, made of natural graphite (C-natural), rotating at 5·10⁵ rpm. The primary source was modeled as a point source, following a Maxwell-Boltzmann distribution with a mean of 0.0378 and a standard deviation of 1554.1 mps. The radial spatial discretization was performed up to 30 groups (Np). Simulations were conducted with 2000 particles, allowing for 500 collisions per particle. The energy spectrum range within the modulator varied up to an energy of 0.56 eV (95% confidence).

FIG. 8 depicts the energy distribution Eₘ in Dₙ(Eₘ, s) of the particles with respect to the radial groups for an MR modulator made of graphite, according to the previously described conditions. The resonant energy spectrum within the modulator ranged from 0.010 to 0.56 eV (95%), where Eₘ=0.56 eV corresponds to the Dₙ(Eₘ, s) distribution at the output of the MR. The maximum distance traveled by the particles in elastic collisions was 1.992 m. The average absorption m.p.f at the position of 0.5 R was 55 m, and the average m.f.p. was 0.114 m. The absorption in graphite accounted for 0.041% of the incident particles.

FIG. 9(a) presents a Normal Distribution function Dₙ(Eₘ,s) fitted for positions ranging from 0.1 R to 0.9 R, in relation to energy, demonstrating the alteration of the spectrum along the depth of the modulator.

FIG. 9(b) shows normal functions fitted to the distribution of the dot product of velocities v1·v2 in relation to the number of interactions occurring in the middle of the rotating ring MR, in groups from 0.1 R to 0.9 R, with a dR=0.5 cm interval.

It is observed that the dot product of velocities v₁·v₂ at the collision position tends to approach unity asymptotically. This indicates that the final direction of the incident particle “1” is tangential to the radius of the modulator whose velocity is v₂.

### Example 3

In this example, a wide range of scattering simulations of particles in modulator media composed of different materials and with varying rotational speeds are analyzed.

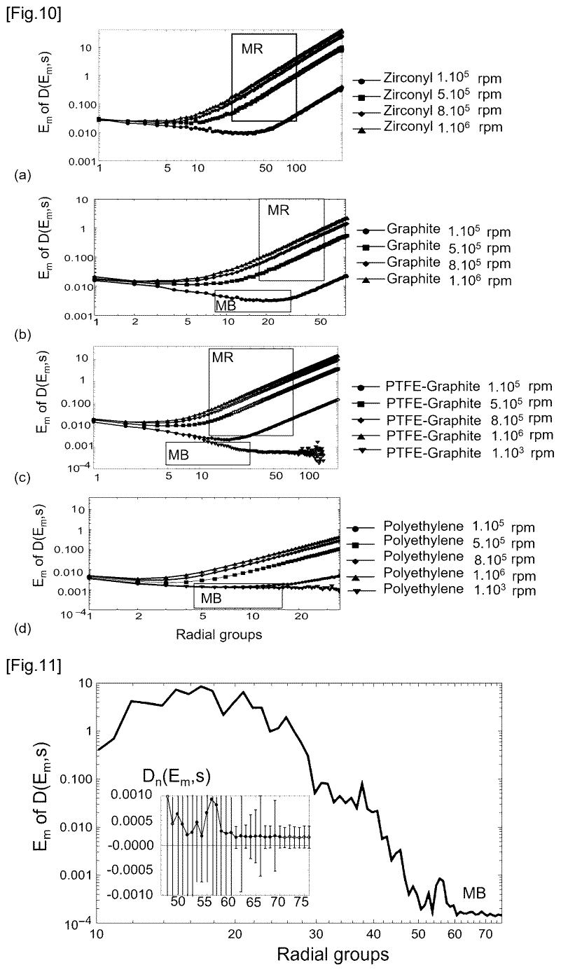

FIG. 10 illustrates the collective energy distribution Dₙ(Eₘ, S) of particles in the modulators, showing the average kinetic energies Eₘ in each radial group dR (with spatial discretization in the Np groups from 1 to 250) along the modulator radii. The modulators were configured with discrete angular speeds of 1·10³, 1·10⁵, 5·10⁵, 8·10⁵, and 1·10⁶ rpm. The investigated materials were Zircaloy, graphite-enriched PTFE, natural graphite, and polyethylene. The particles entering the inner surface of the modulators were generated from an FT source, following a Maxwell-Boltzmann distribution.

FIG. 10 presents the collective behavior of particles, revealing the occurrence of a predominant downscattering process, where the average energy Eₘ of the particles is reduced through collisions as they move away from the source. This process is evidenced by the Log-Log plot (energy vs. radial group), which shows a pattern of decreasing energy (downscattering) followed by a linear growth (log-log) (upscattering). After reaching the minimum energy, the collective average kinetic energy Eₘ of the particles in each group follows a linear function (in Log-Log representation), with a constant slope that depends on the rotation speed but is independent of the material type of modulators.

FIG. 10 presents two distinct regions of interest in the behavior of the average energy Eₘ of the particle distribution Dₙ(Eₘ, s) within the modulators, which are relevant for defining the geometric and material configurations of the resonant spectral selector, RSS MB, and MR.

There is a region of low average energy Eₘ in which the particle distribution exhibits suitable operation for the resonant spectral selector with MB modulator. In this region, the collective kinetic energy of the particles reaches values close to 0.001 eV, allowing for the targeting of materials with high radiative capture or fission cross-sections at low energies, following the 1/v behavior.

FIG. 10 highlights another region that corresponds to the operation of resonant modulators, MR. In this region, it is possible to adjust in the rotation speed of the modulator (wₙ) while keeping the external radius fixed (R_{MR}). These changes in rotation speed allow for adjusting the kinetic energies Eₘ of the particles to make them equivalent to the resonant energies (Eₒ) present in the radiative capture or fission cross-sections of the target nuclei. This region is essential for obtaining an appropriate energy spectrum for the transmutation or fission of the desired materials.

FIG. 10 identifies the energy Eₒ where it is possible to select the appropriate material, radius, and rotation speed to achieve a collective distribution of particles at a specific resonance in the cross-section of the target nucleus. Adjustments in the rotation speed wₙ allow aligning the average kinetic velocity Eₘ of the circulating particles with the resonance energy Eₒ, ensuring maximum absorption in the target and, consequently, the highest possible transmutation. This optimization of the resonant modulator parameters is essential to achieve optimal performance in the radiative transmutation or fission process.

Regardless of the chosen material, the average kinetic energy Eₘ of the circulating particles follows a linear behavior (in a Log-Log plot) with respect to the modulator's rotation speed wₙ and radius. This condition occurs when preferential upscattering takes place. It means that it is possible to alter the average kinetic energy Eₘ of the particles at the outlet surface by varying the modulator's rotation speed wₙ. This linear relationship between the average kinetic energy Eₘ and the nominal parameters of rotation wₙ and radius R is a common characteristic for the investigated materials.

### Example 4

The configuration of an RSS MB selector was considered, consisting of a sequence of a static pre-moderator PM with a thickness of 7.5 cm, followed by a graphite modulator MB. The modulator has an angular velocity wₙ of 10³ rpm and a radius RMB of 30.5 cm. The spatial discretization was performed in 75 radial groups (Np=75).

In this selector, the emission of pre-moderated neutrons through a Li⁷(p,n) source was assumed. This pre-moderation was evaluated in the MCNP code. The source was positioned to have diffusing emission at the external surface of the pre-moderator PM, where an evaluation of the backscattering phenomenon in the pre-moderator was also included. The spatial distribution considered 14 radial groups (Np=14) in PM, and 60 groups in MB, totaling 75 groups.

FIG. 11 shows the average energy Eₘ of the distribution D(Eₘ,s), without explicitly showing the standard deviation s for each distribution. The representation covers the range from 0 to the maximum Np, including the regions of the pre-moderator PM and the modulator MB, considering an FT source at 20. The distribution is amplified for 50-75 radial groups and is represented on a Log-Log scale from 0 to 75 groups, without considering the standard deviation.

FIG. 11 presents, for a modulator with a radius of 30.5 cm, the output neutron distribution Dₙ(Eₘ, s) has an average energy Eₘ (at the surface of the modulator) of 1.64×10⁻⁴ eV, with a standard deviation of 2.2×10⁻³ eV. The maximum distance traveled internally in the modulator during an interaction was 6.61 m. The m.f.p., which represents the average distance traveled before absorption or scattering, was 43.2 m for absorption at 50% of the radius and 0.086 m for scattering at the same position.

FIG. 11 shows that from the radial group Np=65, the average energy of the collective neutrons at the output of the MB modulator reached values below 1 meV, with a reduced standard deviation. A reduction in energy is observed for values below 0.001 eV after the position Np=60, highlighting the entire downscattering process that occurred internally in the MB modulator.

This collective particle distribution adequately satisfies a condition of high radiative capture cross-section of nuclides, following the 1/v behavior observed in various target nuclei.

Thus, the Low-Energy Modulator MB RSS with a graphite modulator rotating at 103 rpm and a radius of 30.5 cm, along with the presence of a static pre-modulator PM of 7.5 cm and a Li⁷(p,n) source, produces a neutron distribution with an average energy of 1.64×10−4 eV and a standard deviation of 2.2×10−3 eV at the outer surface of the MB.

### Example 5

Consider the RSS MM configuration, in which a Zirconium material modulator MM is subjected to a nominal angular rotation wₙ of 8·10⁵ rpm. A total of 200 radial groups (Np=200) were prepared. The primary sources (20) employed were positioned internally in a pre-moderator PM (15) of 7.5 cm, with the following neutron emissions: fission in Watt spectrum (f1), D-D reaction (f2), and Li⁷(p,n) reactions (f3).

FIG. 12 represents the average energy Eₘ of the distribution Dₙ(Eₘ, s) for three classes of MM modulators that cover different energy ranges. The methodology for defining these classes involves calculating the downscattering in the modulator and determining the Np group of interest, which corresponds to Eₘ being close to Eₒ. At this point, the position where the moderation of particles is interrupted is identified, and the recommended value for the radius of the MM modulator, called RMM, is evaluated. In this way, particles are released at the RMM position, resulting in a Dₙ(Eₘ, s) distribution with the average energy Eₘ being closer to the desired resonance energy Eₒ.

FIG. 12 shows that depending on the spectrum of the primary source (f1, f2, or f3), there can be a distribution with a higher average, such as neutron emissions from DD or DT reactions, for example. The interruption energy and the determination of the RMM radius of the MM modulator are provided at higher average energy levels. This can reach up to several keV. This process is distinct from the geometric characterization process used for the MR modulator.

FIG. 12 illustrates that the selected Np positions on the graph correspond to different average energies Eₘ for the spectral distributions D(Eₘ, s) of interest. For example, the Np=80 position (f1) corresponds to an average energy of approximately 50 keV, the Np=150 position (f2) corresponds to around 100 eV, and the Np=100 position (f3) corresponds to approximately 2 eV. Under these conditions, it is important to note that the standard deviation s is larger compared to methods using MB or MR modulators.

### Example 6

FIG. 10 illustrates a set of Dₙ(Eₘ,S) distributions. In this figure, consider the data in the radius domain r from (0.15, 1.0] [m], for the radial groups Np such that r=0.005*(Np+1). The Log-Log graphics show the collective particle distribution Dₙ(Eₘ,S) at radial positions of the modulators as a function of the average kinetic energy Eₘ of particles in taken groups, within 0.15 cm to 1.5 m, for the materials:

natural polyethylene, graphite-enriched PTFE, natural graphite, and Zircaloy, as a function of the axial rotation of the modulator at 1·10³, 1·10⁵, 5·10⁵, 8·10⁵, and 1·10⁶ rpm, previously presented and discussed in Example 3.

These data can be fitted by a mathematical function, suggested to be the energy Eₘ (eV) equivalent to Kr constant multiplied to (w·r)², in which w is the rotation of the module in rpm, r is the radius of the modulator in meters, and Eₘ is the kinetic energy of the incident particle in eV. The fitted values show that K_{f} is equal to 1.37841E-11 with units of eV·rpm⁻²·m⁻².

One can observe that the same value can be obtained through the kinetic energy E is ½ m₁ vᵣ². In rotating media, vᵣ can be written as w·r. Thus, E can be expressed as K_{c}·(w·r)², in which K_{c} is compared to K_{f}. The w is the angular velocity of the nuclei of the rotating modulator medium of in scattering or absorption collisions and m₁ is the mass of the neutron. Conversion factors can be used as: feVJ=1.60218·10⁻¹⁹ eV/Joule; fJeV=6.241506·10¹⁸ Joule/eV; the kg/Da factor fDa=1.66053906660·10⁻²⁷ kg/u.m.a.; and m₁ has a mass of 1.008665 u.m.a. With w in rpm, r in meters, the factor fr=2·π·r/60 is used to convert rpm to m/s. The constant K_{c} can be identified as fr·0.5·m₁·fDa·fJeV.

Therefore, Kr is equal to 1.039 times K_{c}, representing a difference of 3.9% compared to the adjusted value. Note that the distribution graph of average energies Eₘ of the neutron collectivity was evaluated including thermal vibration. Thus, it is expected that the Kr and K_{c} are lightly differed. It can be assumed that the difference is associated with following factors: i) the arbitrarily adopted lower radius limit of 0.15 m for the adjustment; ii) error in the associated adjustment; iii) K_{c} does not consider the thermal vibration introduced in the simulated data, which lightly modifies the direction and value of vᵣ.

It can be concluded that the particle transported by the modulators, regardless of the type of material, assumes the velocity of the atoms in the rotating medium. One can then estimate the angular velocity and radius R_{MR} of the MR modulator that meets the tunneling of a specific resonance energy Eₒ to be considered in the cross-section (XS) of the target nuclide.

Using the same methodology, it is possible to identify a pair (wₙ, R) corresponding to the minimum energy Eₘ observed in the investigated RSS for different materials and angular rotations. In this condition, the optimal position for the operation of the MB modulator can be defined searching the minimum of Dₙ(Eₘ, s) that also meets the diffusion equation.

### Example 7

Consider the RSS MB configuration for use in radiative decontamination of long-lived radionuclides internalized in spent fuel rods stored in reactor pools.

The RSS MB can generate neutron beams in the range of ~1 meV with low standard deviation. The nuclides Th232 and U238 have cross sections (XS) in the region of 1 meV for radiative capture XS(n,g) of 37 b and 13 b, respectively. On the other hand, for XS(n, f), Th232 and U238 have values of 0.28 mb and 0.09 mb, respectively. These XS cross sections are much lower compared to the XS(n,f) and XS(n,g) located in their cold neutron regions for most of the fission product radionuclides (Table 3 to Table 9). Therefore, burning short or long half-live radionuclides using the RSS MB will not produce significant radiative transmutations in fuel containing the fertile elements U238 or Th232, even if the fuel rods are predominantly composed of these non-fissile nuclides after burning.

It can be predicted that the decontamination of fission products (PF) in nuclear fuels using the RSS MB will be a safe method and will not significantly produce fissile residues of the fertile nuclides Th232 and U238. However, since there are different types of nuclear fuels in various Nuclear Power Plants and different burning processes, decontamination studies need to be conducted for each case since atomic concentration shall vary. Each decontamination scenario should be considered using the RSS MB, MR, or MM configurations.

The enrichment of U235 in the uranium fuel pellets in fresh nuclear fuel rods reaches values of 3 to 5 percent. The fission burning of the fuel rods leads to a reduction in this concentration to levels below 2%, approximately. However, such nuclides still exhibit a high fission capability; however, they generally do not sustain a chain reaction in a nuclear reactor as they do not maintain a unity multiplication factor (k) and have internal absorbers originating from fission products (PF). The cross-sections XS(n,g) are 570 b, and XS(n, f) are 3100 b for U235 in cold neutrons, respectively.

Therefore, the RSS MB configuration can be used for the burning of residual U235 in nuclear fuel rods with an enrichment level below 2% through nuclear fission or conversion (n,g). The consumption of residual U235 from fuel rods can reduce concerns regarding nuclear proliferation. Additionally, the thermal energy generated under such conditions can decrease dependence on other energy sources for heating purposes.

In technological terms, the geometric and material configuration presented in this document is already sufficient to enable such an application. The cameras of the peripheral compartments CP can be removed, and the space in the form of a ring can accommodate a support for fuel rods. These rods, once separated from the rectangular fuel assemblies, can be individually and vertically placed in these compartments, ensuring their integrity.

The RSS can operate directly submerged in pools, such as a fuel pool in nuclear power plants, without additional costs and risks associated with fuel movement in a continuous decontamination process. The residual heat can be removed during the additional burning process. Therefore, both the concentration of fission products (PF) and U235 can be reduced in depleted fuel rods within nuclear reactor facilities, employing the present technology.

### Example 8

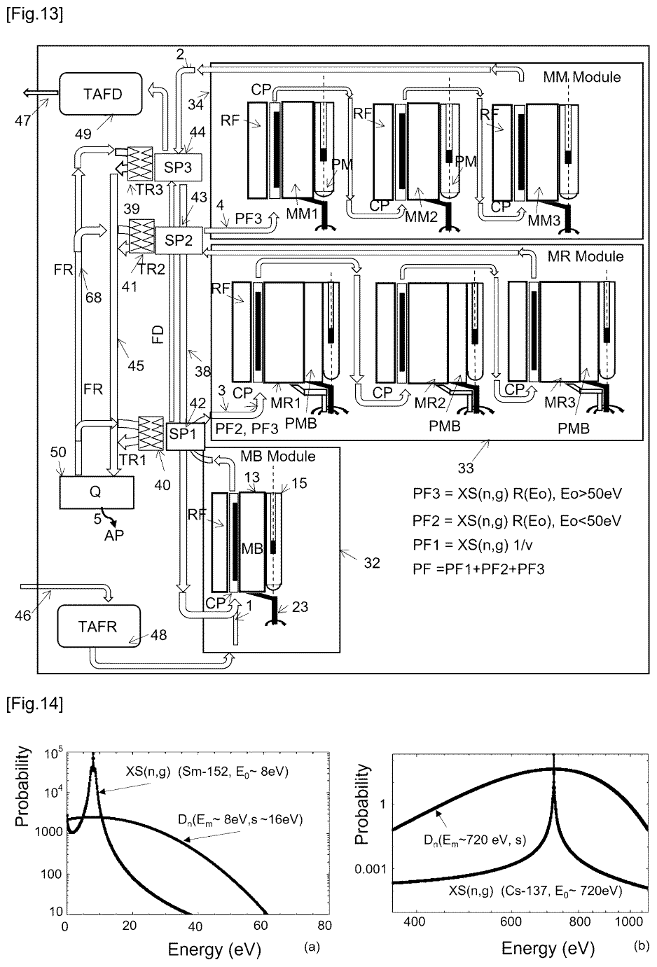

FIG. 13 depicts arrangements of RSS unit modules for radiative decontamination. The arrangement consists of three modules, namely: MB module (32), MR module (33), and MM module (34).

The MB module (32) is supplied with radioactive fluids, which can be sourced from a storage tank (49), but not limited to it. This module caters to neutron activation (n,g), where the target nuclide X(N,Z) has high cross-sections (XS) at low energy (~1 meV) following a 1/v behavior. As a result, such nuclides can be transmuted with cold neutrons. The low-energy region of the energy spectrum is employed in this case to adjust the neutron spectrum to the 1/v cross-sections.

The presented diagram is limited to outlining the radiative flow in the modules, passing it through specific chemical separators for each module, represented by SP1 (42), SP2 (43), and SP3 (44), and heat exchangers TR1 (40), TR2 (41), TR3 (39), corresponding to each module. The sequential TRs of the MB, MR, and MM modules transfer the radioactive decay and transmutation heat to the coolant fluid. The chemical separators SP aid in separating different phases (liquid/gaseous), adjusting concentrations, and removing decontaminated elements from the radioactive fluid, thus allowing the recirculation of the radiative flow. The decontaminated flow can be separated and stored (49). The MB, MR, and MM modules operate for online radiative decontamination during the arrangement's operation.

FIG. 13 illustrates several RSS units per MB, MR, and MM module, {1, 3, and 3}, defined as the minimum value for illustrative purposes. Each module (32, 33, and 34) allows for an increase in the number of units or the customization of units dedicated to specific contaminants according to the Eₘ covered by D(Eₘ, s). For example, Cs-137 can have a specific MM unit, which is not illustrated.

### Example 9

Consider the radiative transmutation of natural Samarium, where the goal is to transmute the 26.75% abundant Sm152 isotope into Sm153 through the reaction Sm152 (n,g) Sm153, with an XS(n,g) of 50,000 b at 8 eV. At the same energy, the natural isotopes of Samarium have XS(n,g) values as follows: Sm144 (3%), 0.1 b; Sm147 (14.9%), 3 b; Sm148 (11.24%), 0.1 b; Sm149 (3.85%), 30 b; Sm150 (7.285%), 2.5 b; and Sm154 (22.75%), 10 b, respectively. Therefore, in the RSS MR device, generating a normalized distribution Dₙ(Eₘ=8 eV), it is possible to activate Sm152->Sm153 with low isotopic contaminants due to the high XS(n,g) at the 8-eV resonance, which is 5000 times higher than the XS of all its natural isotopes present in the sample. Additionally, the Sm154 isotope will produce Sm155, which decays in 22 minutes. Consequently, to avoid contaminants, it will no longer be necessary to perform isotopic enrichment of Sm152 by mass spectrometry before irradiation using an RSS MR.

FIG. 14 illustrates, among other things, the distribution Dₙ(Eₘ=8 eV, s=16 eV) obtained from the RSS MR configuration, tuned for Sm152, plotted together with the XS of Sm-252 at the resonance Eₒ=8.03 eV. Note that the maximum of Dₙ occurs at the energy resonance position.

FIG. 14 presents the Distribution D(Eₘ=720 eV, s=2*Eₘ eV) obtained from the RSS MM, specifically for the element Cs-137. This distribution is plotted together with the cross section (XS) of Cs-137, where the resonance Eₒ is equal to 720 eV.

It is possible to observe that the maximum peak of the distribution D occurs exactly at the Eₘ energy at the resonance Eₒ energy, which favors the optimization of the reaction rate at the specific resonance of Cs-137. This configuration allows for greater efficiency in interacting with Cs-137, maximizing the probability of the desired reaction.

### Example 10

The application of RSS MB can be considered for the transmutation of nuclides from fission waste or radiological contamination processes, regardless of their half-life, whether it is short or long.

Tables 1 and 2 reproduce some nuclear characteristics of certain nuclei that can benefit the most from this RSS MB configuration, without limitation.

Table 1 presents the characteristics of nuclear cross-sections for neutron capture and fission in the 1/v region (1 meV) for radionuclides originating from fission with long half-lives (T_{1/2}>12 m) (References: Nuclear libraries).

Table 2 presents radionuclides commonly found in radiological contamination (T_{1/2}>12 months). (References: nuclear libraries).

Table 3 shows some radionuclides of interest for use in medicine or industry, in a non-restrictive manner, whose precursors can be activated by favorable radiative capture reactions (n,g) in the RSS MB configuration. It can be observed in Table 3 that these precursors exhibit a high (n,g) cross section in energy regions of approximately 1 meV, indicating an inverse proportionality behavior (1/v) of the cross section.

This RSS MB configuration allows optimizing the radiative capture reaction rates. In this case, there is no specific selection of a resonance for a particular nuclide, but all those that exhibit (n,g) or (n,f) cross sections with 1/v behavior in the cold neutron range benefit from a significant increase in the rates of nuclear transmutation or fission reactions

### Example 11

When considering the application of RSS MR, Table 4 and Table 5 provide a list of nuclides, in a non-restrictive manner, along with their nuclear characteristics of neutron absorption at the resonance energies of the (n,g) or (n,f) cross sections. The decontamination of these radionuclides benefits from RSS MR.

These tables include, among others, radionuclides from fission products (Table 4) and long-lived radiological contaminants (Table 5), referenced by nuclear libraries. These radionuclides are of interest to produce radioisotopes used in medicine, whose precursors have high (n,g) cross-sections at resonance energies, using the RSS MR configuration.

Table 6 displays a list of neutron-rich radionuclides, without limitation, that benefit from their production for use in medicine or industry using a resonant RSS configuration. The RSS MR configuration is based on the radiative neutron transmutation of their precursors, shown in Table 6, whose reaction rates are modulated at the resonance energies Eₒ of the XS(n,g).

### Example 12

When considering the application of RSS MM, Tables 7 and 8 provide information about some radionuclides that benefit from the RSS MM configuration.

Table 7 presents the nuclear characteristics of the resonance cross-section XS(n,g) at high energies (>50 eV) for radionuclides originating from fission products and long half-life contaminants. This information is based on nuclear libraries. These radionuclides can be eliminated by the configuration of the MM RSS through radiative transmutation using a neutron distribution generated with an average energy Eₘ, in which the majority do not complete the downscattering cycle, in energy ranges from 50 to 1000 eV.

Table 8 presents the production of neutron-rich radioisotopes that are useful in medicine using a medium energy modulator (MM) through radiative transmutation by neutrons generated with an average energy Eₘ, where most neutrons do not complete the backscattering cycle, at energies ranging from 100 to 900 eV.

Other nuclides of interest that can benefit from MM modulators, operating at their respective resonance energies for XS(n,g), are As76(18 eV), Ra228(20 eV), Ru105(20 eV), Cm242(30 eV), Sn121m (40 eV), 1128(47 eV), Pm143(50 eV), Er169(55 eV), W187(80 eV), TI204(100 eV), Sn117m(240 eV).

### Example 13

The resonant modulators (MR) can be designed based expression Eₘ igual K_{f}·(wₙ·r)². In this case, three classes of MR modulators are proposed: MR1, MR2, and MR3. Thus, the radionuclides that can benefit from each class can be grouped, as outlined in Table 11, listing the nuclides of interest that can be transmuted with MR1, MR2, and MR3 classes.

MR1: Resonant modulator with a radius R_{MR} of 0.45 m and a nominal angular velocity wₙ of 5·10⁵ rpm, designed to accommodate nuclides with XS(n, g) or XS (n, f) with resonances present at energies Eₒ from 0.001 to 1 eV. It can adjust, for illustrative purposes, the nominal energy Eₘ of the collective neutron distribution to be up to 50% higher based on the adjustment of wₙ.

MR2: Resonant modulator with a radius R_{MR} of 0.80 m and a nominal angular velocity wₙ of 8·10⁵ rpm, designed to accommodate nuclides with XS(n, g) or XS (n, f) with resonances present at energies Eₒ from 1 to 6.5 eV. It can adjust, for illustrative purposes, the nominal energy Eₘ of the collective neutron distribution to be up to 50% higher based on the adjustment of wₙ.

MR3: Resonant modulator with a radius R_{MR} of 1·10 m and a nominal angular velocity wₙ of 8·10⁵ rpm, designed to accommodate nuclides with XS(n, g) or XS (n, f) with resonances present at energies Eₒ from 6.5 to 12.5 eV. It can adjust, for illustrative purposes, the nominal energy Eₘ of the collective neutron distribution to be up to 50% higher based on the adjustment of wₙ.

For illustrative purposes, Table 9 and Table 10 outline some material and geometric characteristics of MM and MR modulators that have been divided into classes, without limitations. The pair of operational parameters R and wₙ can take another value.

TABLE 1
Long-lived fission products that match RSS MB.

| Z | A | T½ | T | 1/v XS [b] | Reference |
|---|---|---|---|---|---|
| Se | 79 | 2.900E+05 | y | 50 | (n, g)(N) |
| Cd | 113m | 1.400E+01 | y | 1.00E+05 | (n, g)(N) |
| Sn | 121m | 4.400E+01 | y | 100 | (n, g)(N) |
| I | 129 | 1.500E+07 | y | 180 | (n, g)(F) |
| Sm | 151 | 9.000E+01 | y | 1.00E+05 | (n, g) |
| Ac | 227 | 5.36E+00 | y | 4.00E+04 | (n, g)[F} |
| Th | 229 | 2.18E+01 | y | 180; 300 | (n, f); (n, g)(F) |
| U | 233 | 1.59E+09 | y | 2500; 2500 | (n, f)(n, g)(F) |
| U | 235 | 7.00E+05 | y | 3000; 6000 | (n, f); (n, g) |
| U | 238 | 4.47E+09 | y | 150 | (n, g) |
| Np | 236 | 7.50E+05 | y | 1.00E+04 | (n, g) |
| Pu | 238 | 8.70E+01 | y | 100; 4000 | (n, f); (n, g) |
| Pu | 240 | 6.50E+03 | y | 2.00E+03 | (n, g)(F) |
| Pu | 241 | 1.44E+01 | y | 3000; 1800 | (n, f); (n, g) |
| Pu | 242 | 0.70E+05 | y | 100 | (n, g) |
| Cm | 242 | 1.63E+03 | y | 40; 100 | (n, f); (n, g)(F) |
| Cm | 243 | 2.90E+01 | y | 3E3; 1E3 | (n, f); (n, g) |
| Cm | 244 | 1.81E+01 | y | 75; 5 | (n, g); (n, f) |
| Cm | 245 | 6.50E+03 | y | 20000; 2500 | (n, f); (n, g)(F) |
| Bk | 248 | 7.90E+01 | y | 1.00E+04 | (n, f)(F) |
| Cf | 249 | 3.51E+02 | y | 1E4; 6E3 | (n, f); (n, g)(E) |
| Cf | 250 | 1.30E+01 | y | 800; 2E4 | (n, f); (n, g)(E) |
| Cf | 251 | 9.00E+02 | y | 3E5; 2E4 | (n, f); (n, g)(F) |

TABLE 2
Long-lived radioactive contaminants that match RSS MB.

| Z | A | T½ | T | 1/v XS [b] | Reference |
|---|---|---|---|---|---|
| Na | 22 | 2.600E+00 | y | 800 | 10 meV [J, E] |
| Cl | 36 | 3.010E+05 | y | 1000; 50; 60 | (n, p); (n, a); (n, g) (E, F) |
| Ar | 37 | 2.690E+02 | y | 5000; 300 | (n, g); (n, a); (E) |
| Mn | 53 | 3.700E+06 | y | 600 | (E) |
| Mn | 54 | 3.120E+02 | d | 200; 50 | (n, g); ((E), (N) |
| Fe | 55 | 2.730E+00 | y | 40; 900 | (n, g); (n, a) (E) |
| Ni | 59 | 7.600E+04 | y | 600; 70; 10 | (n, g); (n, a); (n, p) (E, F) |
| Ni | 63 | 1.010E+02 | y | 100 | (E) |
| Zn | 65 | 2.438E+02 | d | 800 | (n, a) (E) |
| Se | 75 | 1.198E+02 | d | 1000 | (N) |
| Te | 127 | 1.090E+02 | d | 1.00E+04 | (N) |
| Cs | 134 | 2.065E+00 | y | 500 | (N) |
| Pm | 146 | 5.530E+00 | y | 5.00E+06 | |
| Eu | 152 | 13.3 | y | 1.00E+03 | |
| Gd | 148 | 7.500E+01 | y | 100 | |
| Gd | 150 | 1.810E+01 | y | 100 | |
| Gd | 153 | 2.410E+02 | d | 6.00E+04 | |
| Dy | 164 | 3.00E+06 | y | 5.00E+03 | (N) |
| Hg | 194 | 5.20E+02 | y | 100 | (N) |
| Tl | 204 | 3.78E+00 | y | 100 | (N) |
| U | 236 | 2.30E+07 | y | 5; 250 | (n, f); (n, g) |
| Pu | 239 | 2.40E+04 | y | 11E4; 2E3 | (n, f), (n, g) |
| Am | 242 | 1.41E+02 | y | 1E4; | (n, f)(E) |
| Cm | 247 | 1.56E+07 | y | 500; 300 | (n, f); (n, g)(F) |
| Cm | 248 | 3.48E+05 | y | 200 | (n, g) |
| Bk | 247 | 1.40E+03 | ya | 500 | (n, f) (E) |
| Bk | 249 | 3.30E+02 | d | 3000 | (n, g) |
| Cf | 252 | 2.60E+00 | y | 200; 100 | (n, f); (n, g)(E) |

TABLE 3
Radionuclides productions that match RSS MB.

| Nuclide | | T_{1/2} | | Precursor | | Abundance | | 1/v XS (n, g) | |
|---|---|---|---|---|---|---|---|---|---|
| Sm | 153 | 46.284 | h | Sm | 152 | 26.75 | % | 1.00E+03 | b |
| Lu | 177 | 6.647 | d | Lu | 176 | 2.599 | % | 1.00E+04 | b |
| Re | 186 | 3.7186 | d | Re | 185 | 37.4 | % | 750 | b |
| Re | 188 | 17.003 | h | Re | 187 | 37.4 | % | 550 | b |
| W | 188 | 69.78 | d | W | 187 | 24 | h | 110 | b |
| W | 187 | 24 | h | W | 186 | 28.43 | % | 200 | b |
| Au | 198 | 2.69 | d | Au | 197 | 100 | % | 500 | b |
| Ho | 166 | 26.8 | h | Ho | 165 | 100 | % | 300 | B |
| As | 76 | 1.0942 | d | As | 75 | 100 | % | 25 | b |
| Xe | 133 | 5 | d | Xe | 132 | 26.9 | % | 1000 | b |
| Tl | 204 | 3.783 | y | Tl | 203 | 29.524 | % | 55 | b |
| Ta | 182 | 114.74 | d | Ta | 181 | 99.98 | % | 100 | b |
| Yb | 169 | 32 | d | Yb | 168 | 0.123 | % | 1.60E+04 | b |
| Ir | 192 | 73.829 | d | Ir | 191 | 0.782 | % | 5000 | b |
| Cr | 51 | 27.7 | d | Cr | 50 | 4.345 | % | 72 | b |
| Co | 60 | 1925.2 | d | Co | 59 | 100.0 | % | 10 | b |
| Dy | 165 | 2.334 | h | Dy | 164 | 28.26 | % | 1.00E+04 | b |

TABLE 4
Long-lived fission products that match RSS MR.

| Nuclide | | Half-live(year) | Eo (eV) | so (b) | Ref |
|---|---|---|---|---|---|
| Tc | 99 | 4.200E+06 | 8 | 5000 | (n, g)(E, F) |
| Pd | 107 | 6.500E+05 | 3.9; 5.2; 6.8; | 80; 40; 10 | (n, g) |
| Cd | 113m | 1.400E+01 | 0.2(*) | 8.00E+04 | (n, g) |
| Sn | 121m | 4.400E+01 | 40 | 80 | (n, g) |
| | | | 72 | 700 | (n, g) |
| Sm | 151 | 9.000E+01 | 1 | 1.00E+04 | (n, g) |
| Eu | 155 | 4.750E+00 | 0.8 | 1.00E+05 | (n, g) |
| Ra | 228 | 1.60E+03 | 30 | 1.00E+03 | (n, g) |
| Ac | 227 | 5.36E+00 | 9 | 2500 | (n, g)(E) |
| Th | 229 | 2.18E+01 | 0.8; 0.8 | 5000; 200 | (n, g)(n, f)(E) |
| Th | 230 | 7.54E+04 | 2 | 1.00E+04 | (n, g) |
| Pa | 231 | 32720 | 0, 5 | 5.00E+03 | (n, g)(E) |
| U | 232 | 6.90E+01 | 7 | 2000 | (n, f) |
| U | 233 | 1.59E+09 | 2; 4 | 1000; 250 | (n, f); (n, g) |
| U | 234 | 2.48E+05 | 8; 8 | 10; 10000 | (n, f), (n, g) |
| U | 235 | 7.00E+05 | 1; 0.5 | 200; 50 | (n, f); (n, g) |
| U | 238 | 4.47E+09 | 8 | 5E3; | (n, g)(E) |
| Np | 236 | 7.50E+05 | 0.8 | 1000 | (n, g)(E) |
| Np | 237 | 2.14E+06 | 0.5; 1.5; 3.8 | 2000 | (E) |
| Pu | 238 | 8.70E+01 | 3 | 1000 | (E) |
| Pu | 240 | 6.50E+03 | 1 | 20; 1E5 | (n, f); (n, g)(E) |
| Pu | 241 | 1.44E+01 | 0.3; 0.3 | 2000; 800 | (n, f); (n, g)(E) |
| Pu | 242 | 3.70E+05 | 2; 3 | 20; 3E4 | (n, f)(n, g)(E) |
| Pu | 244 | 8.00E+07 | 5 | 300 | (n, g)(E) |
| Am | 241 | 4.33E+02 | 0.3; 0.7; 0.4 | 30; 10; 7E3 | (n, f), (n, f); (n, g) |
| Am | 243 | 7.30E+03 | 1.2 | 2E+04 | (n, g)(E) |
| Cm | 242 | 1.63E+03 | 20 | 10; 1E3 | (n, g); (n, f)(F) |
| Cm | 243 | 2.90E+01 | 3 | 2E3; 1E2 | (n, f); (n, g)(F) |
| Cm | 244 | 1.81E+01 | 9; 7 | 100; 10000 | (n, f); (n, g) |
| Cm | 245 | 6.50E+03 | 2.5; 5; 2 | 7E2; 2E3; E2 | (n, f); (n, f); (n, g)(F) |
| Cm | 246 | 4.76E+03 | 5 | 3E+03 | (n, g)(F) |
| Bk | 248 | 7.90E+01 | 1.2 | 5E+02 | (n, f)(T) |
| Cf | 249 | 3.51E+02 | 1 | 7E3; 3E3 | (n, f); (n, g)(E) |
| Cf | 250 | 1.30E+01 | 1; 0.5 | 8E3; 1E5 | (n, f); (n, g)(F) |
| Cf | 251 | 9.00E+02 | 0.4; 0.4 | 3E4; 2E4 | (n, f)(F) |

TABLE 5
Long half-life contaminant radionuclides that
match RSS MR

| Nuclide | | Half-live(year) | | Eo (eV) | so (b) | Ref |
|---|---|---|---|---|---|---|
| Nb | 94 | 2.000E+04 | a | 11 | 1000 | |
| Cs | 134 | 2.065E+00 | a | 10 | 100 | |
| Ce | 139 | 1376E+02 | d | 5 | 5E+04 | (T) |
| Pm | 143 | 1.650E+02 | d | 50 | 100 | |
| Pm | 144 | 3.600E+02 | d | 3 | 500 | (N) |
| Pm | 146 | 5.530E+00 | a | 1 | 5E+05 | (E) |
| Pm | 147 | 2.620E+00 | a | 5 | 5E+04 | (E) |
| Eu | 152 | 13.52 | a | 8 | 3E+04 | |
| Eu | 154 | 8.590E+00 | a | 0.3 | 1000 | |
| Gd | 153 | 2.410E+02 | d | 0.3 | 1E+03 | F |
| Tb | 157 | 7.100E+01 | a | 0.1 | 1E+03 | |
| Tb | 158 | 1.80E+02 | a | 0.1 | 1E+03 | |
| Ho | 163 | 4.57E+03 | a | 1.0(?) | 1E+03 | |
| Tm | 170 | 1.28E+02 | d | 4 | 1E+03 | (E), (F) |
| Tm | 171 | 1.92E+00 | a | 6 | 1E+04 | |
| Lu | 173 | 1.37E+00 | a | 2 | 2E+03 | |
| Lu | 174 | 3.30E+00 | a | 1 | 1E+03 | |
| Lu | 177 | 1.60E+02 | d | 4 | 1E+05 | |
| Ta | 182 | 1.14E+02 | d | 0.2 | 6E+04 | (E), (F) |
| W | 181 | 1.21E+02 | d | 3 | 3E+03 | |
| Re | 186 | 2.00E+05 | a | 5 | 1E+03 | |
| Os | 194 | 6.00E+00 | a | 12 | 1E+09 | (T), (R) |
| Ir | 192 | 2.40E+02 | a | 0.3 | 9E+03 | |
| Pt | 193 | 5.00E+01 | a | 12 | 1.00E+02 | (N |
| Ra | 226 | 1.40E+03 | a | 0.6 | 3E+03 | |
| U | 236 | 2.30E+07 | a | 0.6 | 100; 1E4 | (n, f); (n, g)(J) |
| Np | 235 | 1.00E+00 | a | 0.4 | 600 | (E) |
| Pu | 236 | 2.87E+00 | a | 3 | 5000 | (E) |
| Pu | 239 | 2.40E+04 | a | 4; 2 | 5E3; 2E5 | (n, f)(n, g)(E) |
| Am | 242 | 1.41E+02 | a | 0.3 | 2E+04 | (n, f)(J) |
| Cm | 247 | 1.56E+07 | a | 1.5; 1.5 | 3E+03 | (n, f); (n, g) |
| Cm | 248 | 3.48E+05 | a | 6 | 9E+03 | (n, g) |
| Bk | 247 | 1.40E+03 | a | 1 | 3E+03 | (n, f) (E) |
| Bk | 249 | 3.30E+02 | d | 0.2 | 2E+04 | (n, g)(E) |
| C | 252 | 2.60E+00 | a | 1.2; 1.3 | 200; 45 | (n,f); (n,g)(E) |

TABLE 6
Radionuclides productions that match RSS MR.

| Radionuclide | | Precursor | | Resonance | |
|---|---|---|---|---|---|
| Nuclide | half-life | Nuclide | Abundance | Energy | XS (n, g) |

| | | | | | | | | | | | |
|---|---|---|---|---|---|---|---|---|---|---|---|
| I | 128 | 24.999 | m | I | 127 | 100 | % | 20.00 | eV | 250 | b |
| Sm | 153 | 46.284 | h | Sm | 152 | 26.75 | % | 8.00 | eV | 8E+04 | b |
| Sn | 117 | 13.6 | d | Sn | 116 | 14.54 | % | 100.00 | eV | 100 | b |
| | m | | | | | | | | | | |
| Er | 169 | 9.392 | d | Er | 168 | 26.978 | % | 80.00 | eV | 1E+03 | b |
| Lu | 177 | 6.647 | d | Lu | 176 | 2.599 | % | 0.13 | ev | 1E+04 | b |
| Re | 186 | 3.7186 | d | Re | 185 | 37.4 | % | 1.22 | eV | 3E+04 | b |
| Re | 188 | 17.003 | h | Re | 187 | 37.4 | % | 4.50 | eV | 1E+03 | b |
| W | 188 | 69.78 | d | W | 187 | 24 | h | 4.50 | eV | 5E+04 | b |
| W | 187 | 24 | h | W | 186 | 28.43 | % | 18.00 | eV | 2E+04 | b |
| Au | 198 | 2.69 | d | Au | 197 | 100 | % | 5.00 | eV | 4E+04 | b |
| Mo | 99 | 65.98 | h | Mo | 98 | 24.39 | % | 11.00 | eV | 5.3E+01 | b |
| Ho | 166 | 26.8 | h | Ho | 165 | 100 | % | 3.80 | eV | 7E+03 | b |
| As | 76 | 1.0942 | d | As | 75 | 100 | % | 47.00 | eV | 1.5E+03 | b |
| Ru | 103 | 39.247 | d | Ru | 102 | 31.55 | % | 10.00 | eV | 1.1E+01 | b |
| Ru | 105 | 4.44 | h | Ru | 104 | 18.62 | % | 55.00 | eV | 1E+02 | b |
| Xe | 133 | 5 | d | Xe | 132 | 26.9 | % | 4.35 | eV | 5.20E+04 | b |
| Tl | 204 | 3.783 | y | Tl | 203 | 29.524 | % | 240.00 | eV | 1E+03 | b |
| Ta | 182 | 114.74 | d | Ta | 181 | 99.98 | % | 4.30 | eV | 1E+04 | b |
| Yb | 169 | 32 | d | Yb | 168 | 0.123 | % | 0.60 | eV | 1.50E+05 | b |
| Ir | 192 | 73.829 | d | Ir | 191 | 0.782 | % | 0.65 | eV | 1.50E+04 | b |

TABLE 7
FPs and long half-Life contaminants (CT) match RSS MM

| | | | | | XS(b) | Ref. | Eₒ | | |
|---|---|---|---|---|---|---|---|---|---|
| PF | X | A | Half-life | T | 1 meV | (n, g) | (eV) | S₀(b) | Ref |
| PF | Kr | 85 | 1.076E+04 | y | 8 | (E, N) | 220 | 50 | (n, g)(J) |
| PF | Sr | 90 | 2.878E+01 | y | 0.3; | (J, T, | 1000 | 2.5 | (n, g)(J) |
| | | | | | .05; 3 | N) | | | |
| PF | Zr | 93 | 1500E+06 | y | 10 | (E, N) | 100 | 1000 | (n, g) |
| PF | I | 129 | 1.500E+07 | y | 180 | (F) | 72 | 600 | (n, g)(E) |
| PF | Cs | 135 | 2.300E+06 | y | 50 | (E) | 42 | 3500 | (n, g) |
| PF | Cs | 137 | 3.000E+01 | y | 1 | (F) | 720 | 75 | (n, g)(T) |
| CT | Sn | 123 | 1.292E+02 | d | 0.1 | (N) | 300 | 2 | NGAtlas |

TABLE 8
Radionuclides productions that match RSS MM.

| | | | | | | XS(b) | Eₒ | |
|---|---|---|---|---|---|---|---|---|
| N | A | Half-live | N | A | Valor(%) | 1 meV | (eV) | XS(n, g) b |
| Xe | 135 | 9.14 h | Xe | 134 | 10.435 | 1 | 130 | 10 |
| Co | 60 | 1925.2 d | Co | 59 | 100 | 60 | 200 | 300 |
| Bi | 210 | 5.012 d | Bi | 209 | 100 | 0.2 | 900 | 10 |

TABLE 9
Geometry, material and wₙ parameter for RSS MM.

| Comp. | Material | R(m) | wₙ (rpm) |
|---|---|---|---|
| PM | Polyethylene | 0.075 | 0 |
| MM1* | Graphite | 0.30 | 5.10⁵ |
| MM2* | Graphite | 0.25 | 5.10⁵ |
| MM3* | Zircaloy | 0.20 | 7.10⁵ |
| FT | f1, f2, f3 | 0.015 | 0 |
| CP | Câmara Inox | 0.015 | 0 |
| RF | PTFE-Graphite | 0.10 | 0 |

MM1: ~20-50 eV; MM2: 50-100 eV; MM3: ~100-1 keV.

TABLE 10
Geometry, material and wₙ parameter for RSS MR.

| Comp. | Material | R(m) | wₙ (rpm) |
|---|---|---|---|
| PM | Polyethylene | 0.075 | 0 |
| PMB | PTFEGraphite | 0.08 | |
| MR1 | Graphite | 0.40 | 5.10⁵ |
| MR2 | Graphite | 0.80 | 8.10⁵ |
| MR3 | Zircaloy | 1.10 | 8.10⁵ |
| CP | Câmara Inox | 0.015 | 0 |
| RF | PTFEGraphite | 0.10 | 0 |
| FT | Li⁷(p, n) | 0.012 | 0 |

MR1: 0-1 eV; MR2: 1-6.5 eV; MR3: 6.5-12.5 eV.

TABLE 11
Nuclide types for 3 classes of MR modulators.

| Classes | Nuclide type | Nuclide of interest |
|---|---|---|
| MR1 | Fission Products | Cd113m, Sm151, Eu155, Th229, Pa231, |
| | | U235, Np236, Np237, Pu240, Pu241, |
| | | Am241, Am243, Bk248, Cf249, Cf250, |
| | | Cf251. |
| | Contaminants | Pm146, Gd153, Eu154, Tb157, Tb158, |
| | | Ho163, Lu173, Lu174, Ta182, Ir192, |
| | | Ra226, Np235, U236, Pu239, Am242, |
| | | Bk247, Cm247, Bk249, Cf252 |
| | Precursors | Yb169, Lu177, Ir192 |
| MR2 | Fission Products | Pd107, Th230, U233, Pu238, Pu242, |
| | | Cm243, Pu244, Cm245, Cm246. |
| | Contaminants | Ce139, Pm144, Pm147, Tm170, Tm171, |
| | | Lu177, W181, Re186, Pu236, Cm248 |
| | Precursors | Xe133, Ho166, Ta182, Re186, Re188, |
| | | W188, Au198 |
| MR3 | Fission Products | Tc99, Ac227, U232, U234, U238, Cm244 |
| | Contaminants | Nb94, Cs134, Eu152, Pt193, Os194 |
| | Precursors | Mo99, Ru103, Sm153 |

### INDUSTRIAL APPLICABILITY

The RSS has the capability to be applied in the optimization of nuclear reactions involving radiative capture or fission at very low energy regions, where the target's cross-section (XS) exhibits an inverse proportional behavior to 1/v (with v being the velocity of the incident particle), or in regions of the energy spectrum where well-defined nuclear resonances are present. Its industrial applications can include as i) production of radioisotopes for industrial and medical use; ii) transmutation of a specific isotope into an isotopic mixture of a nuclide X, resulting in either a radioactive or stable product; iii) decontamination of long and short-live radionuclides generated through various nuclear processes; iv) radiological decontamination of fission products generated in nuclear reactors; v) nuclide analysis through neutron activation of samples containing a mixture of various nuclides.

### REFERENCE SIGNS LIST

1. Entry of radioactive fluid into the MB module.
2. Outlet of decontaminated fluid from the MM module.
3. Inlet of circulating fluid in the MR module.
4. Inlet of circulating fluid in the MM module.
5. Chemical processes and heating applications—AP.
6. Metal ring base support.
7. Inner lower metal ring support.
8. Upper lateral metal ring support.
9. Inner upper metal ring support.
10. Peripheral reflector—RF.
11. Perimeter compartment—CP.
12. Cryogenic coolant liquid chamber.
13. Low-Energy modulator—MB.
14. External upper metal ring support.
15. Static pre-moderator cylinder—PM.
16. Inner metal support ring.
17. Rotation speed meter.
18. Rotation speed meter.
19. Internal central tube for source descent or ion transport.
20. Neutron source—FT.
21. Indication of the central axis line of the RSS selector.
22. High-speed rotation axis.
23. Low-speed rotation axes.
24. Low-speed dynamic pre-moderator—PMB.
25. MM1 class modulator.
26. MM2 class modulator.
27. MM3 class modulator.
28. MR1 class modulator.
29. MR2 class modulator.
30. MR3 class modulator.
31. Gear system.
32. MB module for decontamination.
33. MR module for decontamination.
34. MM module for decontamination.
35. Outlet of treated liquid sample.
36. Magnetic connection in MR.
37. Direct connection in MB and PMB.
38. Piping for reverse flow recirculation of radioactive fluid.
39. Heat exchanger TR3 for MM module.
40. Heat exchanger TR1 for MB module.
41. Heat exchanger TR2 for MR module.
42. Chemical separator for MB module.
43. Chemical separator for MR module.
44. Chemical separator for MM module.
45. Outlet pipe of TR with refrigerant fluid.
46. Inlet of radioactive fluid.
47. Outlet of decontaminated fluid.
48. Radioactive fluid storage tank—TAFR.
49. Decontaminated fluid storage tank—TAFD.
50. Coolant fluid tank, heat exchange.
51. Ion accelerator, high voltage.
52. Upper metal base for fixed support of 51, 63, 15.
53. Heating system.
54. Permanent magnet motor.
55. Permanent magnet motor.
56. Magnetic bearing and support.
57. Magnetic bearing and support.
58. Base support structure.
59. Side support structure.
60. Modulator's lower magnetic ring.
61. Modulator fins, connected to the motor shaft.
62. Modulator and PM cooling plates.
63. Cooling system.
64. Pressure control system.
65. Modulator's upper magnetic ring.
66. Upper magnetic ring fixed to the upper structure.
67. Lower magnetic ring fixed to the lower structure.
68. Inlet piping for refrigerant fluid to heat exchangers.
69. Internal target capsule within CP.
70. Screws for magnet adjustment.
71. Perforations in RF for instrumentation input.

### CITATION LIST

Duderstadt, James J, Hamilton, Louis J., Nuclear Reactor Analysis, John Wiley Sons, Inc, Michigan, 1976.
Predisposal Management of Radioactive Waste from Nuclear Power Plants and Research Reactors IAEA Safety Standards Series No. SSG-40, Specific Safety Guides STI/PUB/1719|978-92-0-109815-383 pages.
JEFF-3.3; Joint Evaluated Fission and Fusion File (JEFF), NEA Data Bank, https://www.oecd-nea.org/dbdata/jeff/jeff33/index.html, Accessed 2023.
EAF-2000; Neutron-induced cross section library, The European Activation File: EAF-99-JEFF-3 activation file, 2000.
TENDL-2019; TALYS-based evaluated nuclear data library, A.J. from: Koning, D. Rochman, J. Sublet, N. Dzysiuk, M. Fleming and S. van der Marck, “TENDL: Complete Nuclear Data Library for Innovative Nuclear Science and Technology”, Nuclear Data Sheets 155 (2019).
ENDF-B/VIII.0-Evaluated Nuclear Data Library National Nuclear Data, https://www.nndc.bnl.gov/endf-b8.0/index.html, Accessed: May 2003.
Durkee J. W. et al., MCNP6 moving Objects part I: Theory, Prog. Nucl. Energy, 2016.
Durkee J. W. et al. MCNP6 moving objects. Part II: Simulations. Prog. Nucl. Energy, 2016.
Harrisson G., Li G., Van Der Ende B., Rogger R. B., Tun Z. Simulation of a rotating neutron moderator, Nuclear Instruments and Methods in Physics Research, Section A: Accelerators, Spectrometers, Detectors and Associated Equipment, Vol. 959, 11 Apr. 2020, 163562.

### PATENT LITERATURE

VN1/048166, to Toshinsky, Georgiy Ilich, Method for Long-Term Storage of Waste Nuclear Fuel, 2021.
GB2554068, lan Richard Scott, Simple reprocessing of nuclear fuel waste to produce reactor fuel, 2016.
Wo2016/060867 a1, Smick, Noah, et al. Generating Neutrons Using a Rotating Neutron Source Material.
US2023/0024338, Mark Reed et al, Skewed-Pin (SPIN) Moderator locks for Nuclear Reactors, 2023.

### NON-PATENT LITERATURE

Longfei Xu, Huayun Shen, Junxia Wei, Liujun Pan, A Stable Method for Solving the Simplified Time-Dependent Neutron Transport Equation with Background Motion, Nuclear Science and Engineering, Nuclear Science and Engineering, Vol. 196, 2022, pg. 161-182.
Yuanzineng Kexue Jishu, Study of 3D Neutron Transport Calculation with Moving Background Material. In: Atomic Energy Science and Technology, 2021.
Grammer K. B., Gallmeier F. X., Iverson E. B., A Chopper Extension to model neutron transport with non-static surfaces and high-speed moving media in MCNPX 2.7. Nuclear Instruments and Methods in Physics Research, Section A: Accelerators, Spectrometers, Detectors and Associated Equipment, Vol. 932, 2019, pg. 43-49.
J-Ch Sublet, J. Kopecky, R. A. Forrest Pages 835-839|Published online: 27 Aug. 2014, https://doi.org/10.1080/00223131.2000.108750.

1. Resonant Spectral Selector (RSS) equipment for selective radiative transmutation (n,g) and fissile (n,f), useful in the decontamination of radioactive waste, burning of fission products, production of radioisotopes, and neutron activation analysis, characterized to presenting three distinct individual configurations: RSS MB (FIG. 1), RSS MR (FIG. 2), RSS MM (FIG. 3), and in arrays (FIG. 13), according to the nuclides to be transmuted, whose functionality is to modulate and radially redirect neutrons from a primary source (20) and optimize the nuclear reaction in target-holder compartment (11), generating a collective neutron distribution Dₙ(Eₘ, S), in which Eₘ is the average energy and s is the standard deviation, limited to a selected neutron spectrum over one of the capture (n,g) and fissile (n,f) cross-sections of the target nuclide X(Z,N), with Z ranging from 1 to 110.]

2. [RSS according to claim 1, characterized to being able to have the following components: neutron source—FT (20); static pre-moderator—PM (15); low-energy dynamic pre-moderator—PMB (24); peripheral compartment—CP (11) with target holders (69); peripheral reflector—RF (10); heating system (53); cooling system (65); pressure control system (64); instrumentation (71); neutron-generating source (51); one or more permanent magnet motors (54, 55); rotation meters (17, 18); pairs of magnetic bearings ((65, 60), (60, 67)); essentially, dynamic modulators of one of the MR, MB, MM types, in which RF (10), CP (11), PMB (24), and PM (15) and the modulators are oriented on the same axial axis (21).]

3. [RSS according to claims 1 and 2 characterized to the target-nuclide with XS of either (n,g) or (n,f) is exposed by Dₙ(Eₘ, s) produced by the modulators being of the following types: low-energy modulator—MB (13) (FIG. 1) with Eₘ~1 meV for XS with 1/v behavior; MR (28-30) (FIG. 2) with Eₘ~Eₒ for the Eₒ resonance energy in XS; and medium-energy modulator—MM (25 to 27) (FIG. 3) with Eₘ~Eₒ for the XS resonance, in which Eₘ is reproduced by MB, MM and MR modulators with a defined radius R and angular rotational velocity wₙ.]

4. [RSS according to claims 1, 2, and 3, characterized to the MB, MR, MM modulators and the PMB pre-moderator are solid cylindrical halos with same rotating axial axis, with radium from 0.01 to 2 m, height of 0.01 to 2 m and angular velocity from 5·10² to 5·10⁶ rpm; in which MR and MM modulators allows variation up to 5×in their operational angular velocity wₙ, reproducing Dₙ(Eₘ, S), in which Eₘ is function of wₙ and falls within an arbitrary energy range, referred to classes (FIG. 2 and FIG. 3), covering energy intervals of the resonance energies of Eₒ.]

5. [RSS according to claims 1 to 4, characterized to being composed, in a radial and sequential direction, of the following components: CP (11) and RF (10), and FT (20), PM (15) at the inner center, having RSS MB (FIG. 1) with MB modulator, RSS MR (FIG. 2) with MR modulator, and RSS MM (FIG. 3) with MM modulator, in which the MR modulator belongs to one of the MR classes: MR1 (28), MR2 (29), and MR3 (30), while the MM modulator belongs to one of the MM classes: MM1 (25), MM2 (26), and MM3 (27), whose classes cover non-limiting energy intervals of the resonances on X(N,Z) nuclides.]

6. [RSS according to claims 1 to 5, characterized to the arrangement of one or more units (FIG. 13) of the configurations: RSS MB, MR, and MM, in modules, hold radioactive fluid being transferring from the CPs (11) of the modules (32-34), through the RSS MB (32), RSS MR (33), and RSS MM (34) units, recirculating (34 to 32) with subsequent chemical separation SPi (i=1 to 3, non-limiting) (42-44) of the decontaminated nuclides, in which the heat generated in the RSS is transferred to a refrigerant fluid by heat exchangers TRj (j=1 to 3, non-limiting) (39-41), useful in industrial, chemical, and heating processes.]
